(19) United States
(12) Patent Application Publication
(10) Pub. No.: US 2026/0253004 A1
(43) Pub. Date: Aug. 27, 2026

(54) SYSTEMS AND METHODS FOR INCIDENT AND SERVICE MANAGEMENT

(71) Applicant: Automation Anywhere, Inc., San Jose, CA (US)

(72) Inventors: Muddu SUDHAKAR, Saratoga, CA (US); Antonio NUCCI, San Jose, CA (US); Christos TRYFONAS, Foster City, CA (US)

(21) Appl. No.: 19/214,996

(22) Filed: May 21, 2025

Related U.S. Application Data
(60) Provisional application No. 63/650,781, filed on May 22, 2024.

(51) Int. Cl. G06Q 10/0633

(52) U.S. Cl. CPC G06Q 10/06334

(57) ABSTRACT

Described are methods, systems, and media for incident and service management, comprising: receiving historical alerts, incidents, and/or service tickets; processing the historical alerts, incidents, and/or service tickets and extracting key feature data; grouping the historical alerts, incidents, and/or service tickets into one or more clusters based at least in part on the extracted key features; deriving probabilistic causal relation data between two or more clusters of the one or more clusters; generating an statistical model from the historical alerts, incidents, and/or ticket services, wherein the incident prediction model is configured to predict major service incidents (MIs) from the historical alerts, incidents, and/or service tickets; identifying root cause configuration items (CIs) from the plurality of the historical alerts, incidents, and/or service tickets; and generating a recommendation for service incident interface configured to provide personalized service incident recommendations to a user based on one or more business and operational priorities.

### CROSS-REFERENCE

This application claims the benefit of U.S. Provisional Application No. 63/650,781, filed May 22, 2024, which is hereby incorporated by reference in its entirety herein for all purposes.

### BACKGROUND

Generative artificial intelligence (AI) is artificial intelligence capable of generating text, images, or other media, using generative models. Advances in transformer-based deep neural networks have enabled a number of generative AI systems notable for accepting natural language prompts as input. One such type of model, a large language model (LLM), is a deep learning algorithm that can recognize, summarize, translate, predict, and generate text and other forms of content based on knowledge gained from massive datasets. LLMs cans improve enterprise operations, making them more efficient, accurate, and personalized.

### SUMMARY

In one aspect disclosed herein is a computer-implemented method for incident and service management, the method comprising: receiving a plurality of historical alerts, incidents, or service tickets; processing the plurality of historical alerts, incidents, or service tickets and extracting key feature data; grouping the plurality of historical alerts, incidents, or service tickets into one or more clusters based at least in part on the extracted key features; deriving probabilistic causal relation data between two or more clusters of the one or more clusters; generating an statistical model from the plurality of historical alerts, incidents, or ticket services, wherein the incident prediction model is configured to predict major service incidents (MIs) from the plurality of historical alerts, incidents, or service tickets; identifying root cause configuration items (CIs) from the plurality of the plurality of historical alerts, incidents, or service tickets; and generating a recommendation for service incident interface configured to provide personalized service incident recommendations to a user based on one or more business and operational priorities. In some embodiments, processing the plurality of historical alerts, incidents, or service tickets enables a customer to define a plurality of groups of services based on relative importance to a business or operation of the customer, thereby distinguishing between critical services and important services. In some embodiments, the relative importance is estimated based on the number of outages, users, and configuration items. In some embodiments, processing the plurality of historical alerts, incidents, or service tickets provides the user or the support agent with a recommended ranking of configuration items and business applications. In some embodiments, processing the plurality of historical alerts, incidents, or ticket services ingests and leverages data from one or more different alert monitoring tool or a ticketing system. (a service ticket semantic parsing (STSP) engine) In some embodiments, processing the historical alerts, incidents, or ticket services comprises parsing both the structural and unstructured information uses advance Natural Language Processing (NLP) techniques from machine learning/artificial intelligence (ML/AI). In some embodiments, the unstructured ticket information comprises ticket description, resolution information, and ticket topological information. In some embodiments, processing the historical alerts, incidents, or ticket services comprises parsing unstructured ticket information comprises tagging, normalizing, and extracting one or more key features of the service tickets. In some embodiments, parsing the unstructured ticket information reduces a noise in the unstructured ticket information and leaves a key information needed for a later step. In some embodiments, parsing both the structured and unstructured ticket information is fully automatic and unsupervised by using ML/AI algorithms. In some embodiments, parsing both the structured and unstructured ticket information comprises extracting semantic information from both the structured and unstructured ticket information. In some embodiments, the extracted semantic information comprises a ticket temporal information, wherein the ticket temporal information comprises an overall life-cycle of the service ticket or a change of status from creation to validation of the service ticket. In some embodiments, the extracted semantic information comprises a ticket severity information, wherein the ticket severity information comprises a severity in relation to the SLA. In some embodiments, the extracted semantic information comprises a ticket topological information, wherein the ticket topological information comprises an origin of a service problem within an Enterprise network and an affected element or service. In some embodiments, the extracted semantic information comprises a ticket description and resolution information, wherein the resolution information comprises both a service problem and a final resolution of the service problem at the time of ticket closure. In some embodiments, parsing both the structural and unstructured information further uses advanced Natural Language Understanding (NLU) techniques to impute if one or more key features of the service tickets are missing. In some embodiments, each of the one or more clusters comprises a specific type of issue that occurred previously. In some embodiments, grouping the plurality of historical alerts, incidents, or service tickets uses a MEC algorithm, wherein the MEC algorithm automatically discovers one or more meaningful clusters. In some embodiments, the MEC algorithm learns from a feedback from a user or a support agent. In some embodiments, the MEC algorithm comprises: (a) filtering out one or more service tickets that are not important and do not contribute to one or more major incidents; (b) preprocessing one or more text features; (c) concentrating the preprocessed one or more text features and converting them into one or more vectors; (d) performing a main clustering process; and (e) fine-tuning the one or more larger and meaningful clusters, wherein the fine-tuning comprises a hard split or a soft split. In some embodiments, in (a), the one or more major incidents comprise one or more daily service requests. In some embodiments, in (b), the preprocessing removes stop words, unnecessary characters and tokens, or lemmatization. In some embodiments, in (d), performing the main clustering process comprises a hierarchical structure comprising: (f) performing a first unsupervised clustering with a pre-defined and relatively-large value of total number of clusters (k) and constructing a plurality of small and dense clusters; (g) treating each of the plurality of small and dense clusters as a single data point; (h) performing a second unsupervised clustering on the single data point, thereby merging one or more of the single data point into a larger cluster; and (i) repeating steps (f) to (h) until a meaningful and relatively-sizable representation of clusters are obtained. In some embodiments, in (e), the hard split comprises all of the elements, having the same value for a hard split feature, in each of the clusters. In some embodiments, in (e), a soft split comprises a configurable threshold that specifies a tolerance that a small fraction of an element in one of the clusters can have a different value for a soft feature. In some embodiments, the MEC algorithm is semi-supervised from a key information in the service tickets, wherein the key information comprises categories or configuration items. In some embodiments, the semi-supervision during the main clustering process adds the key information to a ticket feature vector via the MEC algorithm and adjusts the weights of the ticket feature vector according to the importance. In some embodiments, the semi-supervision during the fine-tuning process comprises utilizing one or more labels to decide whether the fine-tuned clusters are further to be split or not. In some embodiments, grouping the plurality of historical alerts, incidents, or service tickets correlates the plurality of historical alerts, incidents, or service tickets with a semantic information extracted from one or more service tickets by the ingesting and the parsing. In some embodiments, grouping the plurality of historical alerts, incidents, or service tickets automatically discovers an effective correlation rule in the absence of a configuration or a supervision from a user or a support agent, thereby effectively aggregating a higher percentage of the plurality of historical alerts, incidents, or service tickets as compared to an alert-correlation system using a plurality of historical alerts, incidents, or service tickets as a main source of information. In some embodiments, deriving the relationship data comprises estimating a causal effect between two or more clusters of the one or more clusters. In some embodiments, deriving probabilistic causal relation data comprises discovering and the estimating apply the Ganger causality and potential outcomes framework for a robust causal inference in Artificial Intelligence for IT Operations (AIOps). In some embodiments, the discovering and the estimating apply a potential outcomes framework for probabilistic causality discovery in AIOps, thereby clustering the plurality of historical alerts, incidents, or serve tickets based on a plurality of ticket fields using advance Natural Language Processing (NLP) algorithms. In some embodiments, each of the clustered historical alerts, incidents, or service tickets comprises a group of historical alerts, incidents, or service tickets that share at least one attribute, wherein the at least one attributes comprise configuration management database (CMDB) configuration item or a similar title or description. In some embodiments, the discovering, and the estimating view the plurality of historical alerts, incidents, or service tickets as a graph of connected clusters. In some embodiments, each of the connected clusters comprises the plurality of historical alerts, incidents, or service tickets that are related to a service incident or an impacted service or application. In some embodiments, the derived probabilistic causal relation is used for a downstream function in Probabilistic Service Incident Prediction (PSIP) and Probabilistic Root Cause Analysis (PRCA). In some embodiments, derived the probabilistic causal relation comprises: (j) applying the Ganger causality test to identify a candidate list of cluster pairs that can have causal relations; (k) applying a potential outcomes causal inference to validate the causal relation and quantify the causal effect; and (l) discovering a hidden configuration item relation based on the discovered probabilistic causal relation. In some embodiments, in (k), applying the potential outcomes causal inference comprises: (m) modeling a cluster causal relationship using a causal graph, wherein the causal graph comprises prior knowledge of a causal relationship between two clusters, a causal relationship to be evaluated, or a cluster of incident tickets; (n) finding any possible ways of identifying a desired causal effect based on the causal graph; (o) estimating the causal effect by using a statistical method, wherein the statistical method comprises propensity-based stratification or propensity-score-matching; and (p) verifying the causing effect by using a robustness method, wherein the robustness method comprises a Placebo Treatment. In some embodiments, deriving the probabilistic relationship data comprises collecting patterns of a set of the plurality of historical alerts, incidents, or service tickets, wherein the set is related to verified impacted services and generate a probabilistic model that improves its robustness on deriving more accurate causality inferences over time. In some embodiments, the statistical model is used to predict a potential service incident. In some embodiments, the statistical model works in conjunction with processing the plurality of historical alerts, incidents, or service tickets to determine when to trigger a notification to a customer based on a selected profile. In some embodiments, the statistical model captures both underlying temporal dynamics and spatial dependencies between different configuration items provided by the identifying root cause configuration items (CIs). In some embodiments, the temporal dynamics comprises an evolution of a service incident from an initial alert of a possible issue to service performance degradation to ultimate service outage and interruption. In some embodiments, the spatial dependencies comprise a probabilistic service map. In some embodiments, the statistical model is auto generated. In some embodiments, the statistical model is a major incident prediction model. In some embodiments, identifying CIs examines the plurality of historical alerts, incidents, or service tickets related to a service incident in order to identify a service problem and group them in the context of the impacted services. In some embodiments, the root cause CIs comprise a CI in a business service from which a root alert for an incident originated and which subsequently triggers additional alerts or incidents. In some embodiments, identifying root cause configuration items (CIs) uses advance ML/AI techniques in order to learn a statistical causality between two or more CIs. In some embodiments, identifying root cause configuration items (CIs) collects historical information about alert and incident patterns related to verified impacted services and to generate a probabilistic model that improves its robustness on driving more accurate causality inferences over time. In further embodiments, the method for incident and service management described herein may further comprise providing a user or a support agent with a user feedback interface configured to receive feedback from the user. In some embodiments, the user feedback interface is configured to provide the user with relevant data and a tool to edit a probabilistic model output. In some embodiments, the user feedback interface is configured to collect feedback and domain knowledge from the user or a support agent to update the recommendation for service incident interface and/or statistical model. In some embodiments, providing the user or the support agent with relevant data and the tool generates an enriched supplementary input for calibrating a probabilistic model. In some embodiments, the relevant data comprises past service incidents that are verified and accepted by the user or the support agent. In some embodiments, the probabilistic model output comprises a confidence score of a derived statistical causal association between two or more CIs or addition of missing CIs. In some embodiments, wherein the user feedback is used to calibrate one or more algorithm to fit the needs of an IT organization. In further embodiments, calibrating one or more algorithm to fit the needs of an IT organization comprises applying a calibration model configured to review the user's feedback and the predicted major service incidents (MIs) to update and/or train the statistical model based at least on the user's feedback, the predicted major service incidents, or a combination thereof. In some embodiments, reviewing the feedback and domain knowledge self-evaluates one or more algorithms. In some embodiments, reviewing the feedback and domain knowledge leverages the feedback and domain knowledge. In some embodiments, reviewing the feedback and domain knowledge comprises continuously collecting new empirical data in real-time to use it to assess compliance of the new empirical data with a model prediction, wherein the model prediction comprises a business service, an incident stage, and a predicted time for stage transition. In some embodiments, reviewing the feedback and domain knowledge increases a confidence score or a trustworthiness of a cluster causal relationship learned by the auto-generating provided that the new empirical data collected in real-time is aligned with the probabilistic model. In some embodiments, reviewing the feedback and domain knowledge decreases a confidence score or a trustworthiness of a cluster causal relationship learned by the auto-generating provided that the new empirical data diverges from the probabilistic model. In some embodiments, auto-generating regularly receives any deviations to auto-calibrate itself. In some embodiments, reviewing the feedback and domain knowledge comprises collecting any changes provided by a support agent by providing the user or the support agent with the relevant data and tool.

In still another aspect disclosed herein is a computer-implemented system comprising at least one processor and instructions causing the at least one processor to perform operations, the system comprising: a custom-tailored recommendation for service incident (CRSI) engine configured to processes a plurality of historical alerts, incidents, or service tickets and generate a tailored rendering and prioritization of a predicted service incident based on an operational need of a customer at a given time; a service ticket semantic parsing (STSP) engine configured to ingest the plurality of historical alerts, incidents, or service tickets and parse both structured and unstructured ticket information; a multi-dimensional clustering (MEC) engine configured to group the plurality of historical alerts, incidents, or service tickets into one or more clusters; a probabilistic causal inference (PCI) engine configured to discover a probabilistic causal relation and estimate a causal effect between two or more clusters; a probabilistic service incident prediction (PSIP) configured to auto-generate a statistical model from the plurality of historical alerts, incidents, or ticket services; a probabilistic root cause analysis (PRCA) engine configured to identify root cause configuration items (CIs); a work-bench annotation (WBA) engine configured to provide a user or a support agent with relevant data and one or more tools to edit a probabilistic model output and collect feedback and domain knowledge from the user or a support agent; and a probabilistic model self-calibration (PMSC) engine configured to review the feedback and domain knowledge from the WBA engine; and predict a service outage from the plurality of historical alerts, incidents, or service tickets. In some embodiments, processing the plurality of historical alerts, incidents, or service tickets enables a customer to define a plurality of groups of services based on relative importance to a business or operation of the customer, thereby distinguishing between critical services and important services. In some embodiments, the relative importance is estimated based on the number of outages, users, and configuration items. In some embodiments, processing the plurality of historical alerts, incidents, or service tickets provides the user or the support agent with a recommended ranking of configuration items and business applications. In some embodiments, processing the plurality of historical alerts, incidents, or ticket services ingests and leverages data from one or more different alert monitoring tool or a ticketing system. (a service ticket semantic parsing (STSP) engine) In some embodiments, processing the historical alerts, incidents, or ticket services comprises parsing both the structural and unstructured information uses advance Natural Language Processing (NLP) techniques from machine learning/artificial intelligence (ML/AI). In some embodiments, the unstructured ticket information comprises ticket description, resolution information, and ticket topological information. In some embodiments, processing the historical alerts, incidents, or ticket services comprises parsing unstructured ticket information comprises tagging, normalizing, and extracting one or more key features of the service tickets. In some embodiments, parsing the unstructured ticket information reduces a noise in the unstructured ticket information and leaves a key information needed for a later step. In some embodiments, parsing both the structured and unstructured ticket information is fully automatic and unsupervised by using ML/AI algorithms. In some embodiments, parsing both the structured and unstructured ticket information comprises extracting semantic information from both the structured and unstructured ticket information. In some embodiments, the extracted semantic information comprises a ticket temporal information, wherein the ticket temporal information comprises an overall life-cycle of the service ticket or a change of status from creation to validation of the service ticket. In some embodiments, the extracted semantic information comprises a ticket severity information, wherein the ticket severity information comprises a severity in relation to the SLA. In some embodiments, the extracted semantic information comprises a ticket topological information, wherein the ticket topological information comprises an origin of a service problem within an Enterprise network and an affected element or service. In some embodiments, the extracted semantic information comprises a ticket description and resolution information, wherein the resolution information comprises both a service problem and a final resolution of the service problem at the time of ticket closure. In some embodiments, parsing both the structural and unstructured information further uses advanced Natural Language Understanding (NLU) techniques to impute if one or more key features of the service tickets are missing. In some embodiments, each of the one or more clusters comprises a specific type of issue that occurred previously. In some embodiments, grouping the plurality of historical alerts, incidents, or service tickets uses a MEC algorithm, wherein the MEC algorithm automatically discovers one or more meaningful clusters. In some embodiments, the MEC algorithm learns from a feedback from a user or a support agent. In some embodiments, the MEC algorithm comprises: (a) filtering out one or more service tickets that are not important and do not contribute to one or more major incidents; (b) preprocessing one or more text features; (c) concentrating the preprocessed one or more text features and converting them into one or more vectors; (d) performing a main clustering process; and (e) fine-tuning the one or more larger and meaningful clusters, wherein the fine-tuning comprises a hard split or a soft split. In some embodiments, in (a), the one or more major incidents comprise one or more daily service requests. In some embodiments, in (b), the preprocessing removes stop words, unnecessary characters and tokens, or lemmatization. In some embodiments, in (d), performing the main clustering process comprises a hierarchical structure comprising: (f) performing a first unsupervised clustering with a pre-defined and relatively-large value of total number of clusters (k) and constructing a plurality of small and dense clusters; (g) treating each of the plurality of small and dense clusters as a single data point; (h) performing a second unsupervised clustering on the single data point, thereby merging one or more of the single data point into a larger cluster; and (i) repeating steps (f) to (h) until a meaningful and relatively-sizable representation of clusters are obtained. In some embodiments, in (e), the hard split comprises all of the elements, having the same value for a hard split feature, in each of the clusters. In some embodiments, in (e), a soft split comprises a configurable threshold that specifies a tolerance that a small fraction of an element in one of the clusters can have a different value for a soft feature. In some embodiments, the MEC algorithm is semi-supervised from a key information in the service tickets, wherein the key information comprises categories or configuration items. In some embodiments, the semi-supervision during the main clustering process adds the key information to a ticket feature vector via the MEC algorithm and adjusts the weights of the ticket feature vector according to the importance. In some embodiments, the semi-supervision during the fine-tuning process comprises utilizing one or more labels to decide whether the fine-tuned clusters are further to be split or not. In some embodiments, grouping the plurality of historical alerts, incidents, or service tickets correlates the plurality of historical alerts, incidents, or service tickets with a semantic information extracted from one or more service tickets by the ingesting and the parsing. In some embodiments, grouping the plurality of historical alerts, incidents, or service tickets automatically discovers an effective correlation rule in the absence of a configuration or a supervision from a user or a support agent, thereby effectively aggregating a higher percentage of the plurality of historical alerts, incidents, or service tickets as compared to an alert-correlation system using a plurality of historical alerts, incidents, or service tickets as a main source of information. In some embodiments, deriving the relationship data comprises estimating a causal effect between two or more clusters of the one or more clusters. In some embodiments, deriving probabilistic causal relation data comprises discovering and the estimating apply the Ganger causality and potential outcomes framework for a robust causal inference in Artificial Intelligence for IT Operations (AIOps). In some embodiments, the discovering and the estimating apply a potential outcomes framework for probabilistic causality discovery in AIOps, thereby clustering the plurality of historical alerts, incidents, or serve tickets based on a plurality of ticket fields using advance Natural Language Processing (NLP) algorithms. In some embodiments, each of the clustered historical alerts, incidents, or service tickets comprises a group of historical alerts, incidents, or service tickets that share at least one attribute, wherein the at least one attributes comprise configuration management database (CMDB) configuration item or a similar title or description. In some embodiments, the discovering and the estimating view the plurality of historical alerts, incidents, or service tickets as a graph of connected clusters. In some embodiments, each of the connected clusters comprises the plurality of historical alerts, incidents, or service tickets that are related to a service incident or an impacted service or application. In some embodiments, the derived probabilistic causal relation is used for a downstream function in Probabilistic Service Incident Prediction (PSIP) and Probabilistic Root Cause Analysis (PRCA). In some embodiments, derived the probabilistic causal relation comprises: (j) applying the Ganger causality test to identify a candidate list of cluster pairs that can have causal relations; (k) applying a potential outcomes causal inference to validate the causal relation and quantify the causal effect; and (l) discovering a hidden configuration item relation based on the discovered probabilistic causal relation. In some embodiments, in (k), applying the potential outcomes causal inference comprises: (m) modeling a cluster causal relationship using a causal graph, wherein the causal graph comprises prior knowledge of a causal relationship between two clusters, a causal relationship to be evaluated, or a cluster of incident tickets; (n) finding any possible ways of identifying a desired causal effect based on the causal graph; (o) estimating the causal effect by using a statistical method, wherein the statistical method comprises propensity-based stratification or propensity-score-matching; and (p) verifying the causing effect by using a robustness method, wherein the robustness method comprises a Placebo Treatment. In some embodiments, deriving the probabilistic relationship data comprises collecting patterns of a set of the plurality of historical alerts, incidents, or service tickets, wherein the set is related to verified impacted services and generate a probabilistic model that improves its robustness on deriving more accurate causality inferences over time. In some embodiments, the statistical model is used to predict a potential service incident. In some embodiments, the statistical model works in conjunction with processing the plurality of historical alerts, incidents, or service tickets to determine when to trigger a notification to a customer based on a selected profile. In some embodiments, the statistical model captures both underlying temporal dynamics and spatial dependencies between different configuration items provided by the identifying root cause configuration items (CIs). In some embodiments, the temporal dynamics comprises an evolution of a service incident from an initial alert of a possible issue to service performance degradation to ultimate service outage and interruption. In some embodiments, the spatial dependencies comprise a probabilistic service map. In some embodiments, the statistical model is auto generated. In some embodiments, the statistical model is a major incident prediction model. In some embodiments, identifying CIs examines the plurality of historical alerts, incidents, or service tickets related to a service incident in order to identify a service problem and group them in the context of the impacted services. In some embodiments, the root cause CIs comprise a CI in a business service from which a root alert for an incident originated and which subsequently triggers additional alerts or incidents. In some embodiments, identifying root cause configuration items (CIs) uses advance ML/AI techniques in order to learn a statistical causality between two or more CIs. In some embodiments, identifying root cause configuration items (CIs) collects historical information about alert and incident patterns related to verified impacted services and to generate a probabilistic model that improves its robustness on driving more accurate causality inferences over time. In further embodiments, the method for incident and service management described herein may further comprise providing a user or a support agent with a user feedback interface configured to receive feedback from the user. In some embodiments, the user feedback interface is configured to provide the user with relevant data and a tool to edit a probabilistic model output. In some embodiments, the user feedback interface is configured to collect feedback and domain knowledge from the user or a support agent to update the recommendation for service incident interface and/or statistical model. In some embodiments, providing the user or the support agent with relevant data and the tool generates an enriched supplementary input for calibrating a probabilistic model. In some embodiments, the relevant data comprises past service incidents that are verified and accepted by the user or the support agent. In some embodiments, the probabilistic model output comprises a confidence score of a derived statistical causal association between two or more CIs or addition of missing CIs. In some embodiments, wherein the user feedback is used to calibrate one or more algorithm to fit the needs of an IT organization. In further embodiments, calibrating one or more algorithm to fit the needs of an IT organization comprises applying a calibration model configured to review the user's feedback and the predicted major service incidents (MIs) to update and/or train the statistical model based at least on the user's feedback, the predicted major service incidents, or a combination thereof. In some embodiments, reviewing the feedback and domain knowledge self-evaluates one or more algorithms. In some embodiments, reviewing the feedback and domain knowledge leverages the feedback and domain knowledge. In some embodiments, reviewing the feedback and domain knowledge comprises continuously collecting new empirical data in real-time to use it to assess compliance of the new empirical data with a model prediction, wherein the model prediction comprises a business service, an incident stage, and a predicted time for stage transition. In some embodiments, reviewing the feedback and domain knowledge increases a confidence score or a trustworthiness of a cluster causal relationship learned by the auto-generating provided that the new empirical data collected in real-time is aligned with the probabilistic model. In some embodiments, reviewing the feedback and domain knowledge decreases a confidence score or a trustworthiness of a cluster causal relationship learned by the auto-generating provided that the new empirical data diverges from the probabilistic model. In some embodiments, auto-generating regularly receives any deviations to auto-calibrate itself. In some embodiments, reviewing the feedback and domain knowledge comprises collecting any changes provided by a support agent by providing the user or the support agent with the relevant data and tool. In some embodiments, the system is disposed between a user computing device and a third-party platform. In further embodiments, the third-party platform comprises one or more of an LLM, a CRM software, or a service agent. In some embodiments, the alert, incident, and/or service ticket is received from a user device or a database. In some embodiments, the historical alerts, incidents, and/or service tickets are received from a database. In further embodiments, the database comprises one or both of a plurality of physical or a plurality of virtual historical alerts, incidents, and/or service tickets.

A still further aspect disclosed herein is one or more non-transitory computer-readable storage media encoded with instructions executable by one or more processors to create an application comprising: a software module configured to perform operations including: receiving a plurality of historical alerts, incidents, or service tickets; processing the plurality of historical alerts, incidents, or service tickets in a custom-tailored recommendation for service incident (CRSI) engine configured to tailor the rendering and prioritization of a predicted service CRSI incident based on an operational need of a customer at a given time; ingesting the plurality of historical alerts, incidents, or service tickets and parsing both the structured and unstructured ticket information in a service ticket semantic parsing (STSP) engine; grouping the plurality of historical alerts, incidents, or service tickets into one or more clusters in a multi-dimensional clustering (MEC) engine; discovering a probabilistic causal relation and estimating a causal effect between two or more clusters in a probabilistic causal inference (PCI) engine; auto-generating a statistical model from the plurality of historical alerts, incidents, or ticket services in a probabilistic service incident prediction (PSIP) engine; identifying root cause configuration items (CIs) in a probabilistic root cause analysis (PRCA) engine; providing a user or a support agent with relevant data and a tool to edit a probabilistic model output to collect a feedback and domain knowledge from the user or a support agent in a work-bench annotation (WBA) engine; receiving the feedback and domain knowledge from the WBA engine in a probabilistic model self-calibration (PMSC) engine; thereby providing an outage prediction to a user or a support agent.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of a computing device; in this case, a device with one or more processors, memory, storage, and a network interface, per one or more embodiments herein;

FIG. 2 shows a first diagram of an exemplary technology stack, per one or more embodiments herein;

FIG. 3 shows a second diagram of an exemplary technology stack; in this case, a technology stack with large language model (LLM) emphasis;

FIG. 4 shows a diagram of an exemplary method of prompt registration configured at an admin console through an LLM gateway, per one or more embodiments herein;

FIG. 5 shows a non-limiting example of a graphic user interface (GUI); in this case, a GUI for an admin console showing artificial intelligence (AI) service desk features;

FIG. 6 shows a non-limiting example of a GUI; in this case, a GUI for an admin console showing AI ops desk features;

FIG. 7 shows a non-limiting example of a GUI; in this case, a GUI for an admin console showing AI support intelligence features;

FIG. 8 shows a non-limiting example of a system architecture for an incident and service management system as described herein;

FIG. 9 shows an exemplary workflow diagram of a multi-dimensional clustering engine as described herein;

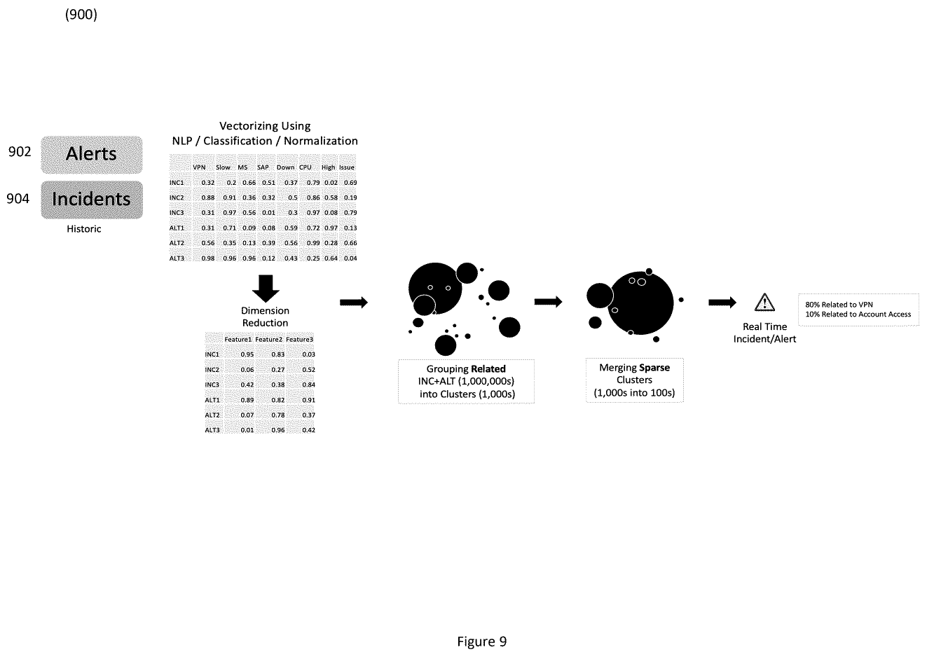

FIG. 10 shows an exemplary workflow diagram of a STSP engine and a MEC engine as described herein;

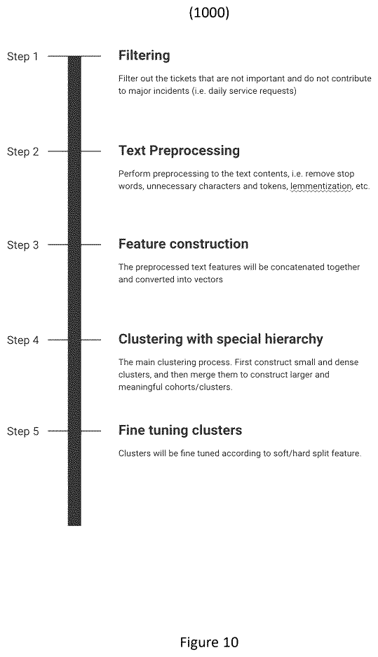

FIG. 11 shows a non-limiting example of a GUI; in this case, a GUI for an viewing a list of discovered tickets belonging to a cluster;

FIG. 12 shows a non-limiting example of a Granger-causes time series graph as described herein;

FIG. 13 shows a non-limiting example of model for graphing causal relationships as described herein;

FIG. 14 a non-limiting example of a table of discovered cluster pairs with causal relations, as described herein;

FIG. 15 a non-limiting example of an anomaly score formula, as described herein;

FIG. 16 shows an exemplary workflow diagram of a SPIP engine for performing major incident detection, as described herein; and

FIG. 17 shows a non-limiting example of a GUI; in this case, a GUI for an viewing a root cause description generated by a PRCA engine, as described herein.

### DETAILED DESCRIPTION

Described herein, in certain embodiments, are computer-implemented methods for incident and service management, the method comprising: receiving a plurality of historical alerts, incidents, or service tickets; processing the plurality of historical alerts, incidents, or service tickets and extracting key feature data; grouping the plurality of historical alerts, incidents, or service tickets into one or more clusters based at least in part on the extracted key features; deriving probabilistic causal relation data between two or more clusters of the one or more clusters; generating an statistical model from the plurality of historical alerts, incidents, or ticket services, wherein the incident prediction model is configured to predict major service incidents (MIs) from the plurality of historical alerts, incidents, or service tickets; identifying root cause configuration items (CIs) from the plurality of the plurality of historical alerts, incidents, or service tickets; and generating a recommendation for service incident interface configured to provide personalized service incident recommendations to a user based on one or more business and operational priorities.

Also described herein, in certain embodiments, are computer-implemented systems comprising at least one processor and instructions causing the at least one processor to perform operations, the system comprising: a custom-tailored recommendation for service incident (CRSI) engine configured to processes a plurality of historical alerts, incidents, or service tickets and generate a tailored rendering and prioritization of a predicted service incident based on an operational need of a customer at a given time; a service ticket semantic parsing (STSP) engine configured to ingest the plurality of historical alerts, incidents, or service tickets and parse both structured and unstructured ticket information; a multi-dimensional clustering (MEC) engine configured to group the plurality of historical alerts, incidents, or service tickets into one or more clusters; a probabilistic causal inference (PCI) engine configured to discover a probabilistic causal relation and estimate a causal effect between two or more clusters; a probabilistic service incident prediction (PSIP) configured to auto-generate a statistical model from the plurality of historical alerts, incidents, or ticket services; a probabilistic root cause analysis (PRCA) engine configured to identify root cause configuration items (CIs); a work-bench annotation (WBA) engine configured to provide a user or a support agent with relevant data and one or more tools to edit a probabilistic model output and collect feedback and domain knowledge from the user or a support agent; and a probabilistic model self-calibration (PMSC) engine configured to review the feedback and domain knowledge from the WBA engine; and predict a service outage from the plurality of historical alerts, incidents, or service tickets.

Also described herein, in certain embodiments, are one or more non-transitory computer-readable storage media encoded with instructions executable by one or more processors to create an application comprising: a software module configured to perform operations including: receiving a plurality of historical alerts, incidents, or service tickets; processing the plurality of historical alerts, incidents, or service tickets in a custom-tailored recommendation for service incident (CRSI) engine configured to tailor the rendering and prioritization of a predicted service CRSI incident based on an operational need of a customer at a given time; ingesting the plurality of historical alerts, incidents, or service tickets and parsing both the structured and unstructured ticket information in a service ticket semantic parsing (STSP) engine; grouping the plurality of historical alerts, incidents, or service tickets into one or more clusters in a multi-dimensional clustering (MEC) engine; discovering a probabilistic causal relation and estimating a causal effect between two or more clusters in a probabilistic causal inference (PCI) engine; auto-generating a statistical model from the plurality of historical alerts, incidents, or ticket services in a probabilistic service incident prediction (PSIP) engine; identifying root cause configuration items (CIs) in a probabilistic root cause analysis (PRCA) engine; providing a user or a support agent with relevant data and a tool to edit a probabilistic model output to collect a feedback and domain knowledge from the user or a support agent in a work-bench annotation (WBA) engine; receiving the feedback and domain knowledge from the WBA engine in a probabilistic model self-calibration (PMSC) engine; thereby providing an outage prediction to a user or a support agent.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together.

Service Ticket: As used herein, “service ticket” in some cases refers to a communication from a user describing one or more technical issues or questions experienced by the user with the purpose of obtaining a resolution to the one or more technical issues or questions.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing Systems

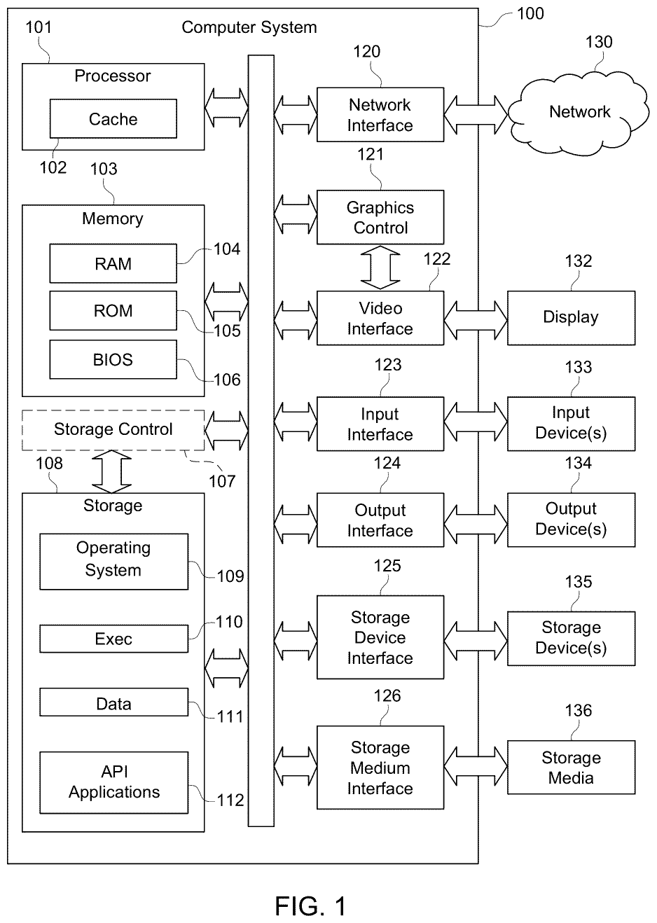

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs) or general purpose graphics processing units (GPGPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition, or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux® and Palm® WebOS®.

### Non-transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, alert, incident, service ticket, key feature, cluster, causal relation, statistical model, and service incident recommendation information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### LLM Technology Stack

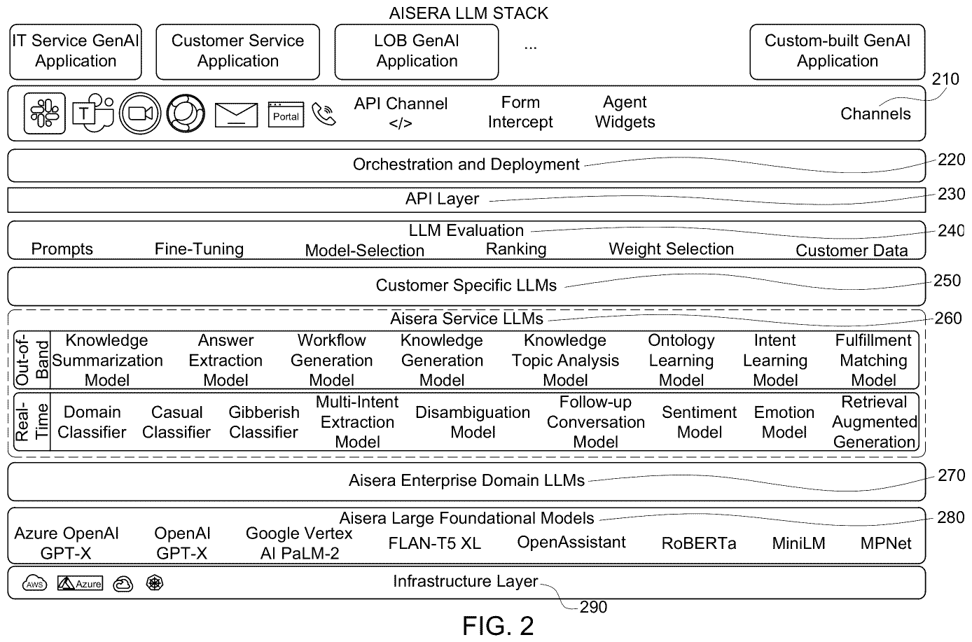

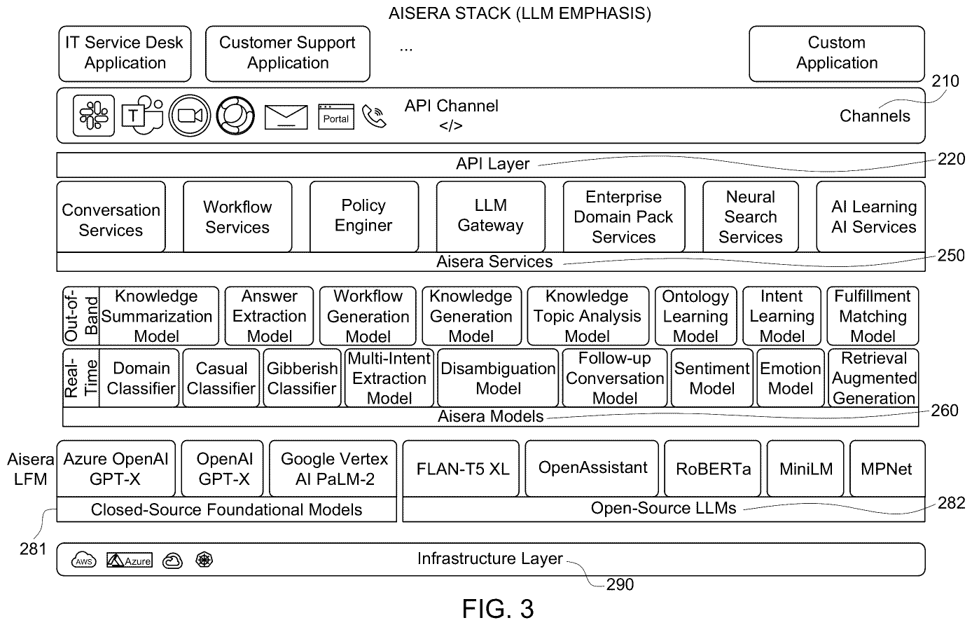

FIGS. 2 and 3 show diagrams of an exemplary Large Language Model (LLM) Technology Stack. In some embodiments, the LLM stack herein can be deployed, scaled, and operated both in public clouds (AWS, GCP, Azure, etc.) on an Infrastructure Layer 290 and locally (on-premise) using the Kubernetes container orchestration platform.

In some embodiments, the LLM stack herein embeds a plurality of large foundational models (LFMs) 280, including both closed-source LFMs 281 via an API layer 230 integrated with LFMs, and open-source LFMs 282 via the LFM deployment and execution in secure Kubernetes containers. Non-limiting examples of closed-source LFM providers which are integrated with The LLM stack herein via APIs are Azure OpenAI (complete and chat APIs for GPT-3, GPT-3.5, and GPT-4), OpenAI (complete and chat APIs for GPT-3, GPT-3.5 and GPT-4), Google Vertex AI (PaLM-2). Non-limiting examples of open-source LFM are FLAN-T5, OpenAssistant, ROBERTa, MiniLM, and MPNet.

In some embodiments, the LLM stack herein enables a developer to choose from a pool of supported LFM/LLM models using a catalog, or to integrate a new LFM/LLM model using the LLM Gateway. In some embodiments, the LLM Gateway Toolkit allows the developer to select the LFM provider of choice, either from a catalog or by selecting “New LFM” (in which case he needs to provide the LFM Provider URL and the API Credentials to establish a successful connection), create a new LLM Group, which is a logical folder associated to the developer, and simply upload the new LLM models in the LLM group.

The LLM stack herein provides the developer with the flexibility of choosing both the LFM framework and a customer-specific LLM model 250 for any given task based on the different LLM services needed to operate a conversational AI assistant. As a result, in some embodiments, developers can develop end to end LLM workflows or LLM services 260 which comprise more than one task by choosing a specific LFM/LLM model for each specific task to be executed in the pipeline.

In some embodiments, developers can calibrate each model per their objectives to deliver a high level of precision and accuracy. In some embodiments, LLM stack herein allows the developer to calibrate the mode using the below behaviors:

Zero-shot Learning: The developer can use the pre-trained LLM model as-is. Examples of such tasks are language detection, language translation, sentiment detection, emotion detection, etc.

Few-shots Learning (e.g., prompt engineering or inference-time tuning): In some embodiments, the developer guides the model to the desired output by providing the LLM model with few examples and instructions. In some embodiments, this calibration model does not alter the underlying parameters of the LLM models.

Instruction-based Fine-Tuning: This method may provide a higher level of precision and accuracy than zero-shot or few-shot learnings. In some embodiments, in this method, the developer trains the model using specialized datasets, which are high-quality human-generated prompt/response pairs specifically designed for instruction tuning LLMs. In some embodiments, this method of calibration acts deeper in the LLM model by updating the internal parameters used by the model. The model fine-tuning is the most advanced calibration method and may require both computing resources for training and supervised, high-quality and extensive datasets to generate the prompt/response sentence pairs for training.

In some embodiments, the Large Language Model (LLM) technology stack herein can operate in multiple industry verticals (e.g., logistics, healthcare, wealth management, retailers, banking, airlines, and insurance) and enterprise domains 270 (e.g., IT, HR, legal and compliance, finance, supply chain management, facilities). The Enterprise Domain LLMs are LLM models which have been extensively fine-tuned using prompt/response sentence pairs extracted from Enterprise Domain Packs (EDPs). In some embodiments, each Enterprise Domain Pack comprises a domain-specific ontology, which is an extensive set of entity classes, entity names, entity synonymous like entity expansions, and abbreviations (initialisms, acronymous, shortenings and contractions) and domain-specific taxonomy, which is an extensive set of intents (and intent phrases) associated to each entity of the ontology. Each domain EDP may comprise hundreds of thousands to millions of intent phrases.

In some embodiments, the Large Language Model (LLM) technology stacks herein use pre-packaged and fine-tuned a large pool of domain-specific LLM Services 260 using one or more EDPs. The LLM Services 260 may be available to developers in a Service LLM catalog. In some embodiments, the developer uses the LLM Services 260 via an API, or can select or drag/drop/chain them into a conversational workflow using a studio to build complete experiences around a service.

In some embodiments, the LLM stack herein provides a further level of LLM model customization beyond the calibration offered via the instruction-fine tuning and EDP. The Large Language Model (LLM) technology stack herein offers special learning pipelines, which act on the specific customer datasets (e.g., tickets, knowledge articles, call transcripts, etc.) which may automatically extract entities and intents which are very specific to the customer (e.g., within the domain of operation). In some embodiments, this custom-specific knowledge is then used to generate custom-specific prompt/responses which may then be used to execute a second round of instruction-based fine tuning on a proprietary Enterprise Domain LLMs, which may be fine-tuned using only the domain-specific EDPs. Exemplary proprietary AI Learning pipelines directly linked to instruction-based fine-tuning pf LLM models are listed below:

Tickets Learning Pipeline: Iteratively and continuously processes tickets and automatically extracts the main entities and associated intents. By grouping tickets tagged with the same pair of intents and entities, the pipeline may automatically generate intent phrases capturing the language diversity used by the specific customer to express the same concept.

Conversation Learning Pipeline: Iteratively and continuously processes user requests and calls transcripts, and automatically extracts the main entities and associated intents. By grouping conversations tagged with the same pair of intent and entity, the pipeline may automatically generate intent phrases capturing the language diversity used by the specific customer to express the same concept.

Knowledge Learning Pipeline: Processes ingested customer knowledge articles and may automatically extract the main entities, associated intents, and large set of intent phrases from each article.

Ontology Generation: Consumes all the entity-based learning from the different pipelines, may automatically discover expansions, abbreviations, and relationships among the entities, and organizes all the entities into an ontology graph which may be made available as a catalog.

Taxonomy Generation: Consumes all the intent-based learning from the different pipelines and may automatically organize all semantic similar intents into a multi-category multi-level intent taxonomy which is made available as a catalog.

In some embodiments, the LLM stack herein provides an LLM evaluation level 240, which the user with a set of toolkits and APIs that developers can use to evaluate the performance of the LLM models herein. Developers can access toolkits and APIs for development, testing and benchmarking the following: prompt engineering (e.g., few shots learning), fine tuning, Model Selection via LLM catalog and LLM Gateway, model performance ranking which automatically scores the models against the same dataset to automatically stack rank LFM/LLM models based on the accuracy achieved, and manage customer datasets for instruction-fine tuning models.

In some embodiments, the LLM stack herein offers a comprehensive Orchestration and Deployment Layer 220 that is used to allocate and deploy resources (including servers, virtual machines, networking, security, and storage), monitor software lifecycle operations, and recover from error conditions. In some embodiments, the LLM stack herein offers a large diversity of channels 210 to interface with users like Slack, Microsoft Teams, Cisco WebEx, Zoom, SMS/MMS, Email and Voice), Administrator Portal, Form Intercept and Agent Widgets.

In some embodiments, prompts can have a separate LLM Provider, internal or external (e.g., OpenAI, Bard, etc.). Input Variables can be passed into prompts (e.g., Chat history). In some embodiments, prompt groups and/or prompt chaining is implemented as well.

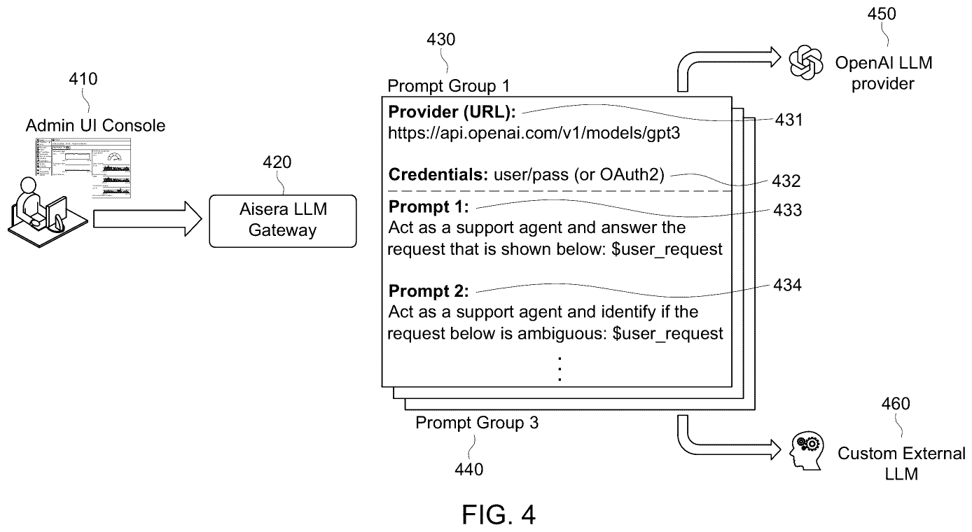

In some embodiments, per FIG. 4, an LLM provider is registered through a LLM Gateway by an Admin UI console 410. In some embodiments, prompts are added that will be used mainly for preconfigured Tasks through the LLM Gateway 420 (e.g., an Admin UI console). In some embodiments, calling the registered prompts can be performed by using a prompt for the main NLU path by inserting them inside the Pre-Handling Flow, or as an auxiliary capacity, by adding prompts inside a flow (e.g., using the new LLM action). In the example shown, a first prompt group 430 comprises a provider URL 431 and the associated credentials 432, a first prompt 433, and a second prompt 434. As shown, the first prompt 433 and the second prompt 434 of the first prompt group 430 are sent to an OpenAI LLM provider 450. Further, a second prompt group 440 is sent based on its provider URL (not shown), to a custom external LLM 460. In some embodiments, the LLM Gateway 420 determines, based on the prompt, the provider URL 431, the associated credentials 432, or any combination thereof whether to send the prompt to the OpenAI LLM provider 450 or to the custom external LLM 460. In some embodiments, the LLM Gateway 420 sends the prompt to the OpenAI LLM provider 450 for general prompts that can be answered by the OpenAI LLM provider 450. In some embodiments, the LLM Gateway 420 sends prompts specific to an organization, an application, or other specialized department to the custom external LLM 460.

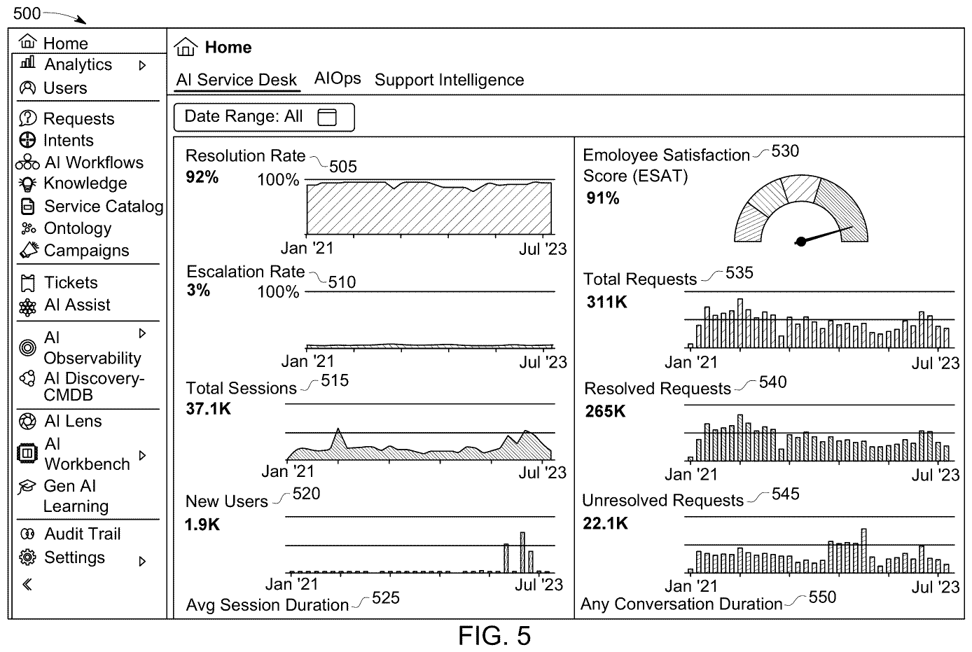

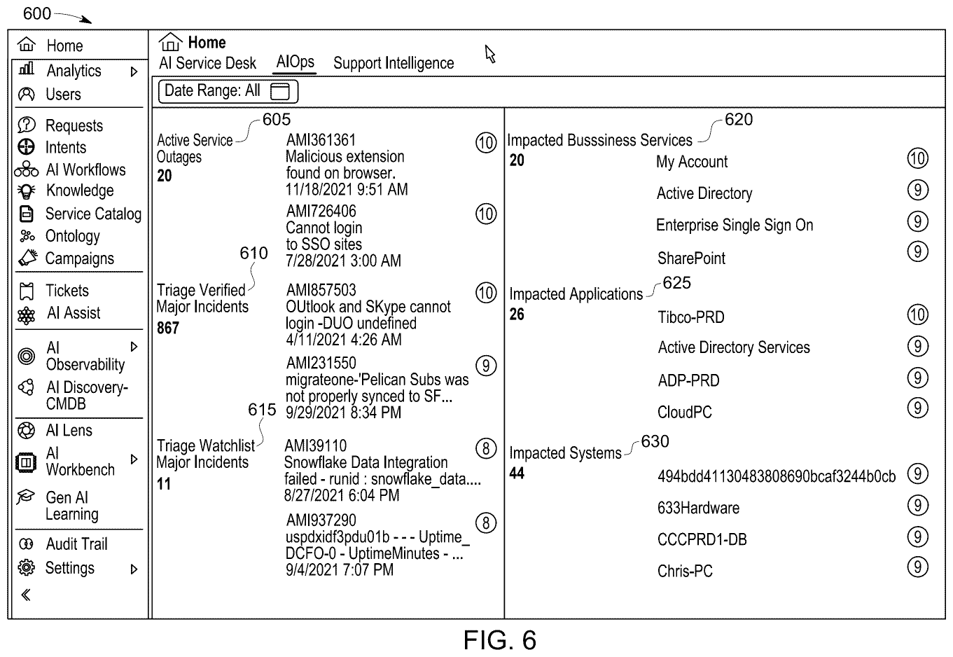

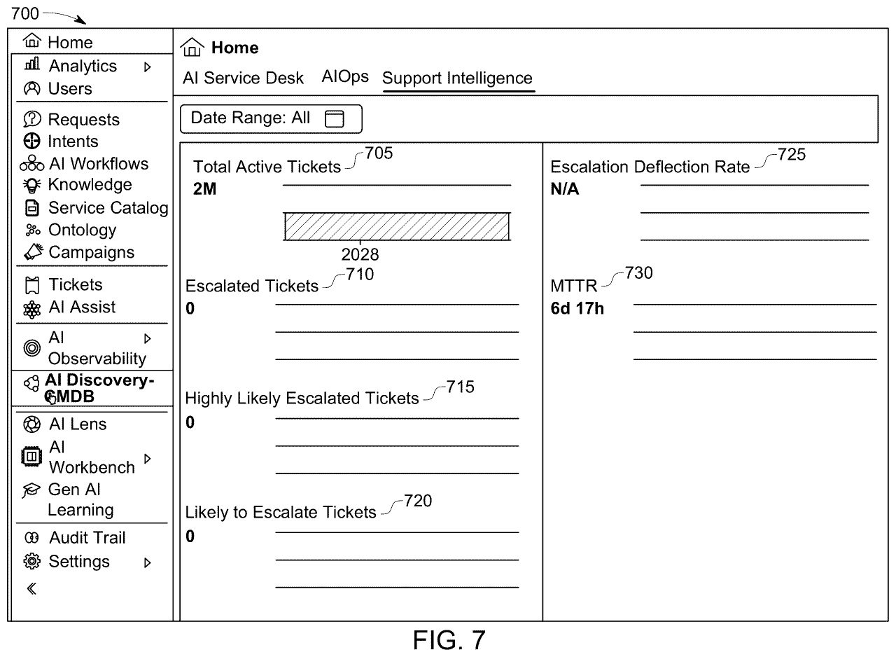

In some embodiments, technology stack described herein includes an administrative (or admin) console. In further embodiments, the admin console includes a front-end interface, such as a GUI. In still further embodiments, the GUI includes features allowing an admin user to review and configure features of the technology described herein. By way of example, in some embodiments, per FIG. 5, a GUI for an admin console 500 includes navigation elements allowing a user to access, by way of examples, analytics, users, requests, intents, AI workflows, knowledge bases, service catalogs, ontologies, campaigns, tickets, AI assist, AI observatory, AI discovery, AI lens, AI workbench, gen AI learning, an audit trail, and settings. Further, in some embodiments, per FIG. 5, a GUI for an admin console 500 includes an AI service deck feature providing access to data pertaining to, for example, resolution rates 505, escalation rates 510, total sessions 515, new users 520, average session duration 525, employee satisfaction score 530, total requests 535, resolved requests 540, unresolved requests 545, and average conversation duration 550. By way of further example, in some embodiments, per FIG. 6, a GUI for an admin console 600 includes an AI ops feature providing access to data pertaining to, for example, active service outages 605, triage verified major incidents 610, triage watchlist major incidents 615, impacted business services 620, impacted applications 625, and impacted systems 630. By way of still further example, in some embodiments, per FIG. 7, a GUI for an admin console 700 includes an support intelligence feature providing access to data pertaining to, for example, total active tickets 705, escalated tickets 710, highly likely to escalate tickets 715, likely to escalate tickets 720, escalation deflection rate 725, and mean time to recovery, repair, respond, or resolve (MTTR) 730.

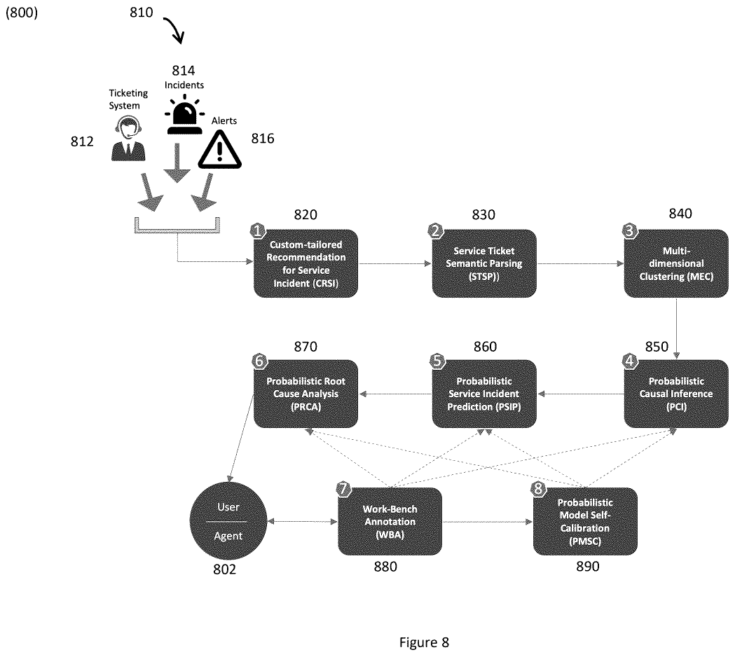

In FIG. 8 the logical architecture of the system 800 is illustrated. The system 800 may comprise one or more a custom tailored recommendation for service incident (CRSI) engine 820, a Service Ticket Semantic Parsing (STSP) engine 830, a multidimensional clustering engine 840, probabilistic causal interface (PCI) engine 850, a probabilistic service incident prediction (PSIP) engine 860, a probabilistic root cause analysis (PRCA) engine 870, a workbench annotation engine (WBA) 880, and a probabilistic model self-calibration (PMSC) engine 890.

The system 800 may take as an input 810 data from different sources. The system 800 may receive input data 810 from at least one of alert monitoring tools 816, incident reporting systems 814 and ticketing systems 812. The system 800 may be able to take input data 810 from different sources, regardless of the domain. This domain-agnostic feature provides a more complete picture of organizational IT health.

The (CRSI) engine 820 may be configured to tailor the rendering and prioritization of predicted service incidents given one or more operational needs of one or more given customers at any given time. Without the CRSI engine 820, customers, irrespective of their sizes, vertical domains, and business priorities, would be forced to unanimously adapt the same ranked recommendations for service incidents, irrespective of their business and operational priorities. The CRSI engine 820, may allow for customers to define multiple groups of services based on their relative importance to either the business and/or operations. This may help the system 800 distinguish between critical services (impacting one or more business units) that if abruptly interrupted will cause financial loss, damage, or interruption to the delivery of “goods or services” to customers, and important services that if affected will impact the efficiency and effectiveness of the organization.

The CRSI engine 820 may be configured to help prevent showing issues to an agent's 802 which have no domain expertise for the issue. For example, showing a surfacing business application related issues to an agent on the infrastructure team. The CRSI engine 820 may be configured to address questions like what are critical and less critical configuration items relevant to each IT team and/or what level of risks is an IT team willing to tolerate based on different levels of criticality? The CRSI engine 820 may be configured to capture information regarding and/or identify configuration items and business applications associated with an alert or incident from input data 810 received by the system 800. In some cases, the CRSI engine 820 may identify configuration items and business applications associated with an alert or incident from the information is present in the input data 810. In some cases, the CRSI engine 820 may predict configuration items and business applications associated with an alert or incident from the input data 810 when the information is missing from the input data 810. In some cases, the CRSI engine 820 automatically identify or predict the configuration items and business applications associated with an alert or incident from the input data 810. In some cases, the CRSI engine 820 identifies and/or predicts the configuration items and business applications associated with an alert or incident from the input data 810 in real-time. In some cases, the CRSI engine 820 identifies and/or predicts the configuration items and business applications associated with an alert or incident from the input data 810 response to an instruction or prompt. In some cases, the prompt may come from an agent 802. In some cases, the prompt may come from one or more engines in the system. In some cases, the CRSI engine 820 may estimate a criticality of a business application depending on the number of outages, users, and configuration items associated with an alert or incident received. In some cases, the CRSI engine 820 may automatically estimate the criticality of a business application depending on the number of outages, users, and configuration items when a criticality is not present in the input data 810. The CRSI engine 820 may further help determine associations between different IT teams and configuration items.

In some cases, when a user 802 from Team A logs into the system 800, he may receive a custom-tailored view of configuration items and business applications based on what is relevant to that user. In some cases, the user 802 may further receive a recommended ranking of business applications and configuration items. The user 802 may have the option of improving the predicted ranking to serve his needs the best.

In some cases, one or more users 802 may curate a major incidents (MI) watch list. The MI watchlist may be based at least in part on the user(s) 802 feedback. After the MI watchlist is curated for the one or more users 802, a sensitivity of the algorithms for the users' notification and formation of major incidents can be configured. The algorithms for the users' notification and formation of major incidents can be configured to have a sensitivity ranging from very conservative to very aggressive. Users 802 may have the option of either adjusting the knobs on the details of multiple algorithms or using a single simplified knob, which is based on the combination of different knobs. In some cases, agents 802 may modify one or more parameters of these algorithms at any time. In some cases, only verified or authorized agents 802 may modify the one or more parameters of these algorithms.

The STSP engine 830 may be configured to receive the input data 810 and extract semantic information from the input data 810. The STSP engine 830 may be configured to receive the input data 810 and extract semantic information from both structured and unstructured fields of the input data 810. In some cases, the input data comprises at least service incident records and/or service incident tickets. The STSP engine 830 may use one or more advanced Natural Language Processing (NLP) techniques from ML/AI to extract the semantic information from both structured and unstructured the input data 810 (e.g., from service tickets). In some cases, the extracted information include one or more of ticket temporal in-formation—which details the overall life-cycle of the ticket and change of status from creation to validation; ticket severity information—which details its severity in relation to the SLA; ticket topological information—which details the origin of the problem within the Enterprise network and the affected element or service; and/or ticket description and resolution information—which may be unstructured and details both the problem and the final resolution of the problem at time of ticket closure. Using advanced NLP techniques, the STPS engine 830 may parse key features from ticket description and resolution information and/or from ticket topological information. The STSP engine 830 may consolidate one or more parse key features to construct feature vectors. The STPS engine 830 may deliver the feature vectors to the Multi-dimensional Clustering engine 840.

In some case, the Service Ticket Semantic Parsing engine 830 may use one or more advanced Natural Language Processing (NLP) techniques from ML/AI to parse the structured and unstructured ticket information. The STSP engine 830 may be configured to parse unstructured information such as ticket description, resolution information and ticket topological information using various NLP techniques to tag, normalize and extract key features. The STSP engine 830, may be configured to reduce noise in the unstructured information. The STSP engine 830, may be configured to denoise input data 810 leaving key information to be processed by one or more engines of the system 800 further down the pipeline. The STSP engine 830, may be configured to leave key information critical to one or more engines of the system 800 further down the pipeline. In some cases, parsing process performed by the STSP engine 830 may be fully automatic and unsupervised. In some cases, the fully automatic and unsupervised process is performed using one or more ML and/or AI algorithms. In some cases, the STPS engine 830 may allow a user/agent 802 to identify key information. In some cases, the key information input by the user/agent 802 may include topological information. In some cases, the STPS engine 830 may allow a user/agent 802 to identify key information using regex patterns. In some cases, the STPS engine 830 may further utilize one or more Advanced Natural Language Understanding techniques (NLU) to impute if one or more key features are missing from the input data 810 and/or the parsed data. In some cases, the STPS engine 830 may synthesize and construct feature vectors from the parsed key features and/or key features determined using NLU. The feature vectors may be deliver to the MEC engine 840.

In some cases, a Multi-dimensional Clustering (MEC) engine 840 may be configured to receive feature vectors from an STPS engine 830. In some cases, a Multi-dimensional Clustering (MEC) engine 840 is configured to use one or more clustering algorithms. The MEC engine 840 may correlate one or more alerts and/or incidents with the rich semantic information extracted from service tickets by the STSP engine 830. The MEC engine 840 may automatically discover effective correlation rules with no configuration or supervision needed from support agents 802. This allows the MEC engine 840 to more effectively aggregate a higher percentage of alerts and incidents when compared with traditional alerts correlation systems. By more effectively aggregate a higher percentage of alerts and incidents, the MEC engine 840 can more effectively filter out alerts, incidents and tickets which are not related (explicitly or implicitly) to service problems. The MEC engine 840 help prevent users/agent 802 (e.g., operational teams) from receiving non-relevant incidents and tickets and instead focus their time on incidents to each user/agent or team. Furthermore, our system can more precisely categorize incidents for optimal hand-off to the right operational personnel and optimally prioritize incidents based on actual SLAs signed with Enterprise organizations and/or external customers as defined by our STSP module.

In some cases, the MCE engine 840 uses one or more Multi-dimensional Clustering algorithms to group incidents 814 and alerts 816 into meaningful cohorts, as referred to as clusters throughout the specification. Each cohort/cluster may present a specific type of issue that has been occurring. In some cases, the MCE engine 840 will take into account various fields from incident and alert contents to build each cohort. As described in the STSP engine 830, the raw information 810, either structured or unstructured, will be transformed into useful reduced-dimension features and passed on to the clustering algorithms of the MCE engine 840. The clustering algorithm is able to perform one or more of 1) automatically discover meaningful clusters; 2) incrementally learn from new data; and/or 3) learn from user feedback.

The MEC 840 may be configured to perform one or more actions in a semi-supervised way. The supervision here may not come from the user/agents, but rather from existing key information in tickets (i.e., categories, configuration items, etc.). In some cases, a bottom algorithm for main clustering is unsupervised, but the clustering result will respect these supervisions. In some cases, the supervision may happen in two ways. A first way may happen during the main clustering process, the algorithm will add the key ticket information to the ticket feature vector, and adjust their weights in the feature vector according to their importance. The weight-adjusted feature vector may be the final content on which the clustering will be performed. A second way may happened during the fine-tuning clustering process, the algorithm may utilize the labels to decide whether clusters will need to split further. In some cases, both ways or a combination of the two ways may be used.

In some cases, the main clustering process follows a specific hierarchical structure. The main clustering process may comprise a first attempt, wherein the algorithm will look at the whole dataset. The algorithm may then perform an unsupervised clustering with pre-defined and relatively large value of k (k=total number of clusters). The algorithm may then construct many small and dense clusters. After, each small and dense cluster may be treated as one data point, wherein the total number of data points at this stage becomes k. In some cases, a similar unsupervised clustering may be performed on these data points, and may be merged into larger cohorts. In some cases, the main clustering process may be repeated until a meaningful and relatively sizable representation of clusters/cohorts has been constructed.

In some cases, the fine-tuning clustering process occurs after the main clustering process. The fine-tunning clustering process may perform further adjustments (i.e., splits) to the clusters constructed from the main clustering process. The further adjustments may be made based at least in part on key features. In some cases, there may be two types of split: “hard” or “soft.” In some cases, a hard split means all the elements in one cluster need to have exactly the same value for one or more hard-split features. In some cases, a soft split may have a configurable threshold, which specifies a tolerance that a small fraction of the element in one cluster can have different values for one or more features.

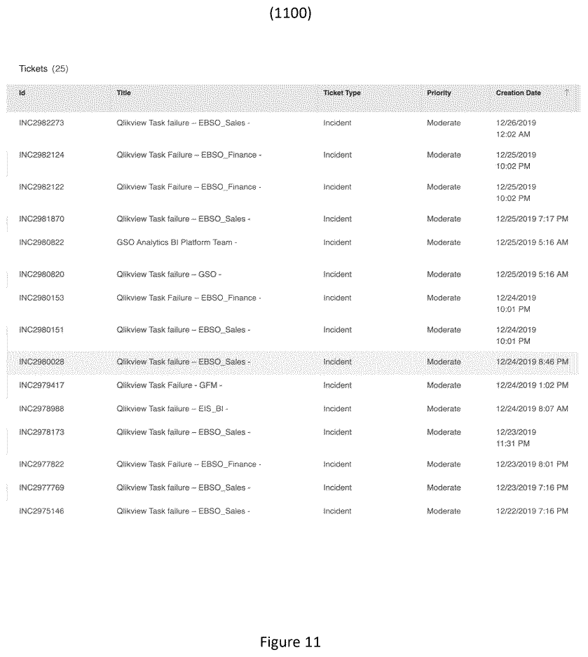

In some cases, a probabilistic causal inference (PCI) engine 850 may be configured receive the output from the MEC engine 840. The PCI engine 850 may be configured to analyze the output from the MEC engine 840 and discovers the probabilistic causal relations and/or estimate the causal effect between two or more clusters. In some cases, the PCI engine 850 may apply the Ganger causality and Potential Outcomes framework to provide more robust causal inference in the context of AIOps). In some cases, the PCI engine 850 views the incident/alert ticket system as a graph of connected clusters. In some cases, each clusters consists of a large number of alerts, incidents and service tickets related to service incidents, i.e., issues with the common subject raised by users), or an impacted service/application, i.e., a configuration item (CI). FIG. 11 illustrates a list of tickets 1100 that were determined to belong to the same ticket cluster. In this example, the majority of the tickets are related to the “Qilkview Task Failure.” In some cases, the relationships between CIs involved in a service incident may not all be deterministic in nature (meaning distinct CIs can be associated together with zero probability of error), the PCI engine 850 may use advanced ML/AI techniques to learn statistical causality between CIs. This may allow the PCI engine 850 to collect historical information about alert and incident patterns related to verified impacted services and generates a probabilistic model that improves its robustness on deriving more accurate causality inferences over time. In some cases, the causal relations determined by the PCI engine 850 can be used for various downstream functions of the Probabilistic Service Incident Prediction (PSIP) engine 860 and/or the Probabilistic Root Cause Analysis (PRCA) engine 870.

In some case, the PCI engine 850 is used in the context of AIOps. Here, tickets (incidents, alerts and changes) are clustered based on various ticket fields using one or more NLP algorithms. Each cluster maybe a group of tickets sharing some common attributes (e.g., CMDB CI, similar title/description). For example, as illustrated in FIG. 11, the list of tickets 1100 are discovered belonging to the same ticket cluster. The majority of the tickets are related to the “Qilkview Task Failure” issue in this example. The PCI engine 850 views the incident/alert ticket system as a graph of connected clusters. Each of the clusters may consist of a large number of alerts, incidents and service tickets related to service incidents, i.e., issues with the common subject raised by users), or an impacted service/application, i.e., a configuration item (CI). The PCI engine takes the output from MEC Alert/Incident Clustering and discovers the probabilistic causal relations and estimates the causal effect between clusters.

For the example in FIG. 11, the system 800 wants to discover if the tickets in incident cluster related to “Qilkview Task Failure” are caused by any other ticket clusters (i.e., issues) or have caused issues in any other clusters.

The PCI engine 850 may infer causal relations between two or more clusters through two steps: (1) A Granger causality test, and (2) A potential outcomes causal Inference. The Granger causality test can be used to identify a candidate list of cluster pairs that may have causal relations. The potential outcomes causal inference may further validate causal relations and quantify causal effects.

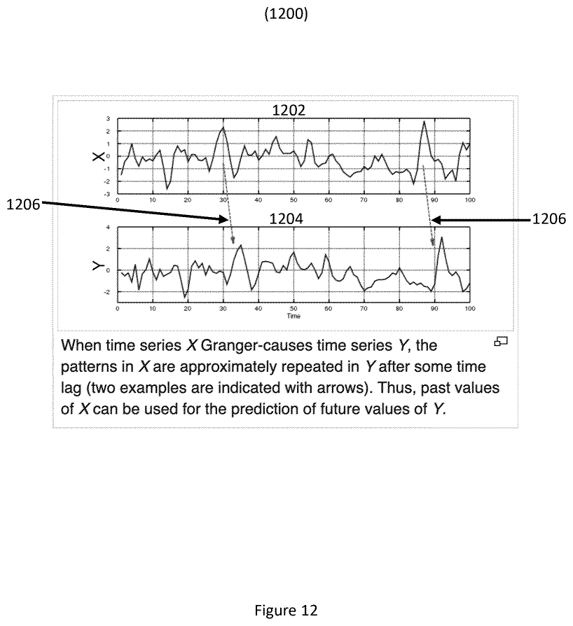

In some cases, the PCI engine may run a Granger causality test between a given pair of clusters (e.g., historic ticket occurrence in time series) to determine if Granger causality exists between the two clusters. In some cases, the PCI engine is configured to evaluate the Granger causality between time series of ticket occurrence (counts) in each cluster determined by the MEC engine 840. As illustrated in FIG. 12, a Granger causality exists if a signal X 1202 “Granger-causes” (or “G-causes”) a signal Y 1204, then past values of X should contain information that helps predict Y above and beyond the information contained in past values of Y alone. Charts 1200 show that Granger causality 1206 exists between time series X 1202 and Y 1204.

In some cases, the PCI engine 850 may perform a potential outcomes causal inference, following the Granger causality tests. The potential outcomes causal inference methods are used to estimate the causal effect between two or more ticket clusters.

The causal effect defines the difference between what happened and what would have happened. For example, for each subject there can be a pair of potential outcomes associated them, Y(0) and Y(1). Y(0) denotes the outcome that would result if the subject does not receive the treatment, and Y(1) denotes the outcome that would result if the subject does receive the treatment. Defined this way, the treatment effect for the subject is simply Y(1)-Y(0). Y(0) and Y(1) are called potential outcomes because only one of them will be realized and observed. In some cases, described herein, Y(1) can mean ticket an occurrence (or counts) in the outcome cluster if there is treatment (or impact) from the treatment cluster. Y(0) can mean a ticket occurrence (or counts) in the outcome cluster if there is no treatment (or impact) from the treatment cluster.

In some cases, the PCI engine can apply potential outcomes to the causal inference framework for probabilistic causality discovery and effect estimation using one or more steps. The one or more steps may comprise one or more of: i) model, ii) identify, iii) estimate and iv) refute.

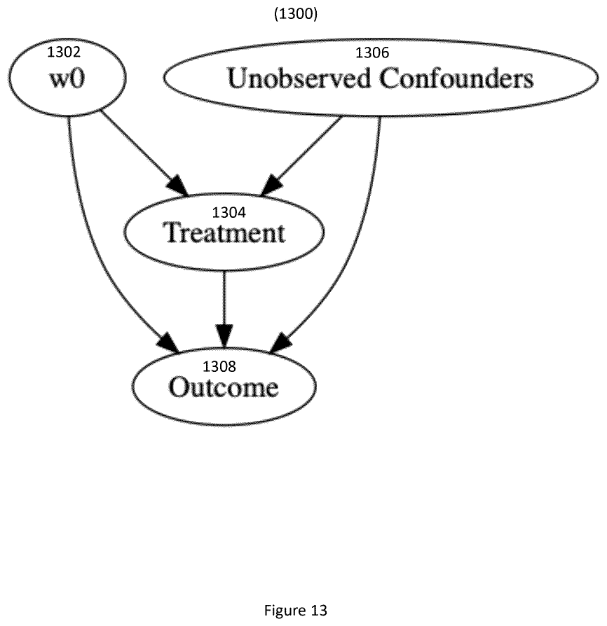

In some cases, the one or more steps may comprise the model step. The model step may comprise modeling cluster causal relationships using a causal graph 1300, as illustrated in FIG. 13. In some cases, the graph 1300 may include a prior knowledge node, referred to as w0 1302, which may comprise prior knowledge of the causal relationships between two or more clusters. In some cases, the graph 1300 also include a treatment node 1304 which may comprise the causal relationship to be evaluated, e.g., causal relationship between a cluster of changes type tickets. In some cases, the graph 1300 may include an outcome node 1308 which may comprise a cluster of incident type tickets. In some cases, the graph 1300 also include an unobserved confounders node 1306.

In some cases, the one or more steps may comprise the identify step. The identify step may include using the input graph to find all possible ways of identifying a desired causal effect based on the graphical model. In some cases, the identify step may use graph-based criteria and do-calculus to find potential ways of expressions that can identify the causal effect.

In some cases, the one or more steps may comprise the estimate step. The estimation step may estimate the causal effect using statistical methods such as propensity-based-stratification or propensity-score-matching.

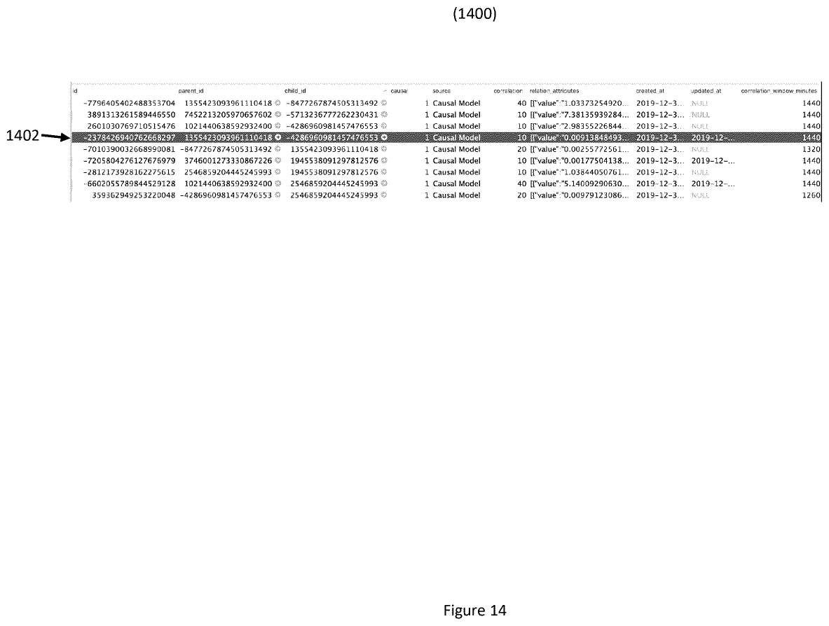

In some cases, the one or more steps may comprise the verify step. The verify step may use robustness methods such as placebo treatment to verify the validity of the causal effect. In some cases, the PCI engine 850 may be configured to discover hidden configuration item relations based on discovered causality. In some cases, each ticket cluster has only one configuration item due to the clustering algorithm setting. This may allow the PCI engine 850 to easily derive the configuration item relations based on the cluster pairs with discovered causality. For example, FIG. 14 shows an table 1400 of discovered cluster pairs with causal relations. The clusters listed in the “child_id” columns are treatment clusters and the clusters listed in the “parent_id” columns are outcome clusters. For the cluster pair 1402 {“child_id”:−4286960981457476553, “parent_id”: 1355423093961110418}. In some cases, the PCI engine 850 can identify the configuration items of the cluster pair 1402 and add the pair of identified configuration items as a newly discovered configuration item relation.

In some cases, the system 800 comprises a probabilistic Service Incident Prediction (PSIP) engine 860. The PSIP Engine 860 may be configured to process historical alerts, incidents and tickets to auto-generate statistical models of historical service incidents. The statistical models of historical service incidents may capture the underlying temporal dynamics (evolution of a service incident from early warnings of a possible issue to service performance degradation to ultimate service outage and interruption) and spatial dependencies (probabilistic service map) between different configuration items (e.g., applications and systems) provided by the PRCA engine 870. The statistical model generated by the PSIP engine 860 may be trained using the historical service incidents. PSIP engine 860 may then be configured to apply the trained models to predict potential service incidents in the future based on one or more active tickets, alerts, incidents, or a combination thereof. In some cases, a confidence score is determined for each prediction generated from the trained model. In some cases, the prediction model may identify a historical service incident as similar to the predicted service incident. The prediction model may determine the historical service incidents as similar to the predicted service incident based on a similar nature or dynamics of the historical service incident to the predicted service incident. In some cases, the PSIP engine 860 may work in conjunction with the CRSI engine 820 to decide when to trigger a notification to the customer based on his selected profile.

In some case, the PSIP engine 860 may be configured to receive alert/incident clusters and casual inference data from the MEC engine 840 and PCI engine 850. The PSIP engine 860 may be configured to identify anomalous behaviors (i.e., major incidents) based on the information received from the MEC engine 840 and PCI engine 850. The PSIP engine 860 may further estimate a severity of a major incident at the moment (i.e., impact score) and near future (i.e., outage prediction) based on the time-series analysis of clusters from the MEC engine 840. In some cases, each alert and incident comprise timestamp fields associated with them (e.g., start time, updated time, assigned time, etc.). The PSIP engine 860 may be configured analyze the timestamp fields associated with alerts and incidents and construct time-series data for each cluster for discovering major incidents (MIs). The PSIP engine 860 may analyze the distribution of the historic time-series of clusters, to calculate a baseline for each cluster. The baseline can indicate the expected number of alerts/incidents at a given hour of the day and day of the week. This allows the system 800 to take into account the seasonality with the assumption that the underlying number of alerts/incidents follow a different pattern each day of the week and each hour of the day. In a non-limiting example, the SPIP engine 860 may repeatedly observed that weekdays have a higher volume of alerts/incidents than weekends. In some cases, the PSIP engine may observed a higher volume of alerts/incidents in a 1^{st} portion of the week compared to the 2nd portions of the week, or a higher volume of alerts/incidents during working hours compared to not working hours.

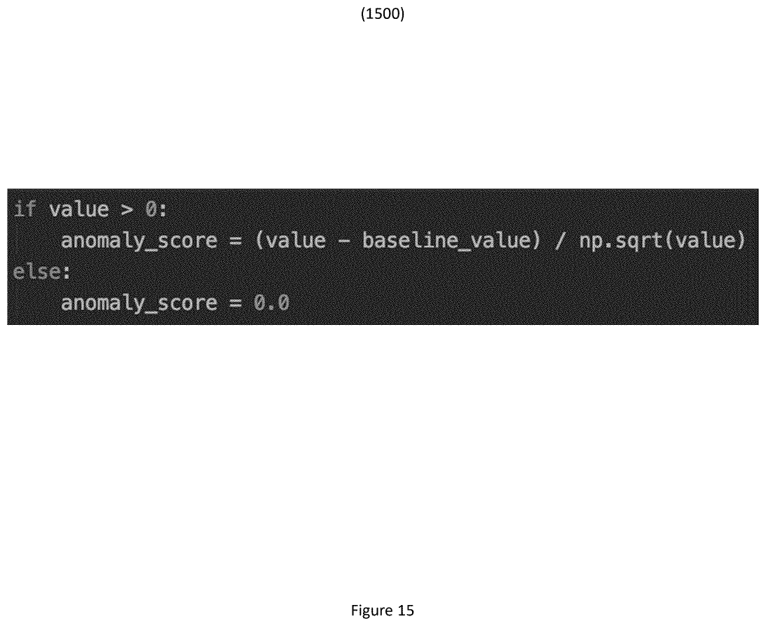

In some cases, the PSIP engine 860 may discover anomalous behavior by comparing the established baseline for each cluster with the observed volume of alerts and incidents. The PSIP engine 860 may apply one or more methods for quantifying the difference between the established baseline for each cluster with the observed volume of alerts and incidents. In some cases, the PSIP engine 860 may leverage an anomaly score formula to quantify the difference. In some cases, the anomaly formula may use a modified version of the Luminol package (https://github.com/linkedin/luminol) for quantifying the difference. The PSIP engine 860 may use one or more factors to determine a notable anomaly at any given time. In some cases, four factors are combined to determine a notable anomaly at any given time. The combined four factor may comprise two factors that can be directly configured and two factors influenced by the user. FIG. 15 illiterates and exemplary anomaly score formula using a combined four factors to determine a notable anomaly at a given time. The anomaly formula comprises an expected number of alerts/incidents (baseline_value); an observed number of alerts/incidents (value); an anomaly score threshold (minimum anomaly score); and a minimum alerts/incidents count. For the exemplary anomaly formula illustrated in FIG. 15, the observed value is used as denominator instead of baseline value (which is the original Luminal algorithm formula) to boost the score when the evidence of an anomaly is stronger. For example, these two scenarios would have led to the same score, using (value-baseline)/baseline, but with very different implications:
Observed: 100, Baseline: 50→anomaly score=2.
Observed: 10, Baseline: 5→anomaly score=2.

It is normally assumed that a higher number of observed incidents/alerts leads to a higher confidence. Therefore, the square-root of value is used as the denominator as an alternative heuristic. With this formula, the anomaly scores for above examples will be 7.1 and 2.4, respectively.

In some cases, there are two deciding factors for declaring an anomaly significant—Anomaly Score Threshold, and Minimum Alerts/Incidents Count. These two factors may control the sensitivity of the algorithm for detecting anomalies and can be configured by agents 802. The aggregation window for constructing time-series (e.g., count of incidents/alerts in 30 minutes vs 60 minutes) may be configurable. In some cases, the minimum time between two consecutive major incidents such that the two major incidents are considered can be modified by the user 802. These configurations can be set independently for different clusters and issue types.

In some cases, the anomaly scores are unbounded measures. The anomaly scores may range from 0 to even 1000s and do not follow any specific analytical distribution. Additionally, different clusters can have different ranges. The PSIP engine 860 may convert and normalize anomaly scores into more intuitive indicators. The converted and normalized anomaly score may be converted into impact scores.

In some cases, the PSIP engine 860 may calculate an impact score of the major incidents of a cluster, the PSIP engine 860 may calculate an impact score of the major incidents of a cluster, based on one or more of the following factor: a percentile of a calculated anomaly score based on historical data; a percentile of a number of impacted users based on historical data; ap priority and severity of incidents/alerts of a major incident; a criticality of configuration items impact; an importance of users impacted; and agents feedback on past similar major incidents.

In some case, an impact score is translated into one or more stages based on the score value. In some case, an impact score is translated into three stages of a major incident. The three stages may include, early warning (score<=4), degraded performance (4<score<=7), and service outages (score>=8). The employed percentile threshold (e.g., [50th, 70th, 90th]) for anomaly score and impact users for calculating impact score can be modified by the user.

In some cases, the PSIP engine may determine a title for a major incident. The title of the major incident may be determined by choosing the most concise and the most relevant title from its associated incidents and alerts. The PSIP engine 860 may do this by first constructing a centroids vector of all word tokens of all the titles from the associated incidents and alerts. The PSIP engine 860 may select the title with closest distance (e.g., Jaccard Distance) to that centroid. The selected title may then be used as the major incident title.

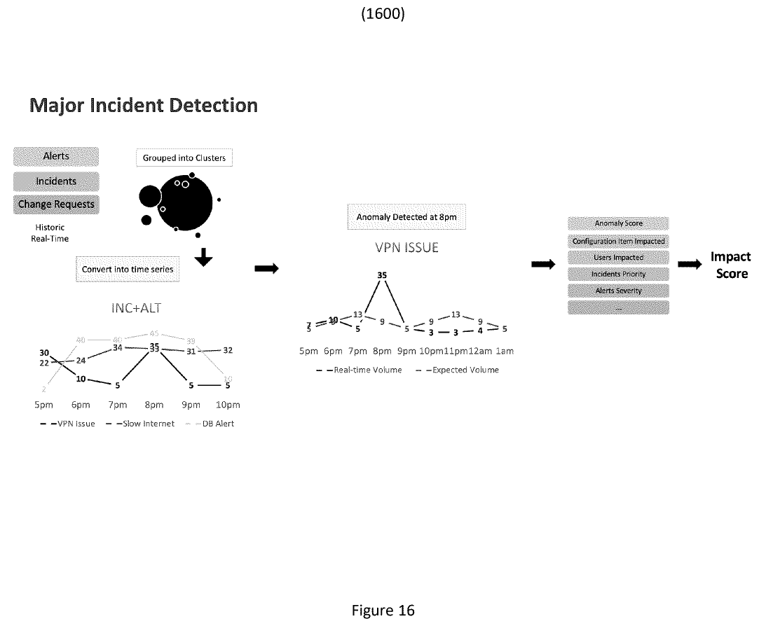

In some cases, the PSIP engine 860 may generate a major incident timeline to summarize the trend of major incident severity (stages) along with the future predictions of a major incident. The major incident timeline can show when the incident is discovered. In some cases, the major incident timeline may show at what time the incident transitions from a first stage to a second stage (e.g., from an early warning stage to the degraded performance stage). The PSIP engine 860 may utilize an outage prediction model for generating an outage prediction for a major incident. The outage prediction model may be configured to predict how many more incidents/alerts are expected to be created in the near future and how many more users are at risk as a result of the major incident. In some cases, the outage prediction model continuously monitors the health of one or more applications and services by modeling and inferring the interactions of one or more entities (e.g., servers, users, application) topology of a company. The outage prediction model may use the over-time behavior of the one or more entities. As illustrated in FIG. 16, the STSP engine 830 and the MEC engine 840, may form clusters for one or more configuration items. The SPIP engine 860 may apply the outage prediction model to the clusters for one or more configuration items to perform multi-dimensional time series statistical modeling on the anomalies from these clusters. The outage prediction model may use Vector Autoregression (VAR). For example, the outage prediction model may apply formula one below:
y_it: anomaly score of configuration item tickets cluster i at time t
a_ij: impact of cluster j on cluster i

$$[ \begin{matrix}{y}_{1 , t} \\ {y}_{2 , t}\end{matrix} ] = [ \begin{matrix}{c}_{1} \\ {c}_{2}\end{matrix} ] + [ \begin{matrix}{a}_{1 , 1} & {a}_{1 , 2} \\ {a}_{2 , 1} & {a}_{2 , 2}\end{matrix} ] [ \begin{matrix}{y}_{1 , t - 1} \\ {y}_{2 , t - 1}\end{matrix} ] + [ \begin{matrix}{e}_{1 , t} \\ {e}_{2 , t}\end{matrix} ]$$

The outage prediction module can analyze and discover all possible interactions between the configuration items. By way of example, if a file system error (y_{1}) will immediately lead to shut down of an application service (y_{2}), the model will find a significant impact a_{2, 1}. Using all the significant impacts that have been discovered by outage prediction, future predictions of a major incident can be made.

In some cases, the system 800 comprises a probabilistic root cause analysis (PRCA) engine 870. The probabilistic root cause analysis (PRCA) engine 870 may be configured to sifts through the overwhelmingly large number of alerts, incidents and service tickets related to a service incident to identify the underlying problems. The PRCA engine 870 may group the alerts, incidents and service tickets in the context of the impacted services, and identify the root cause Configuration Items (CIs). The root cause CI may be a CI in a business service from which the root alert for an incident originated and which subsequently triggered additional alerts and incidents. Because the relationships between CIs involved in a service incident are not all deterministic in nature (meaning distinct CIs can be associated together with zero probability of error), the PRCA engine 870 may use advanced ML/AI techniques to learn statistical causality between CIs. This allows the PRCA engine 870 to collect historical information about alert and incident patterns related to verified impacted services. The PRCA engine 870 may them generate a probabilistic model that improves its robustness based on receiving from the PCI engine 850, more accurate causality inferences over time.

In some cases, the PRCA engine 870 can leverage the discovered causal relations from the PCI engine 850. The PRCA engine can leverage the discovered causal relations from the PCI engine 850 in one or more ways. One way may include constructing a causal view for the current major incident. Another way may include generating a root cause description.

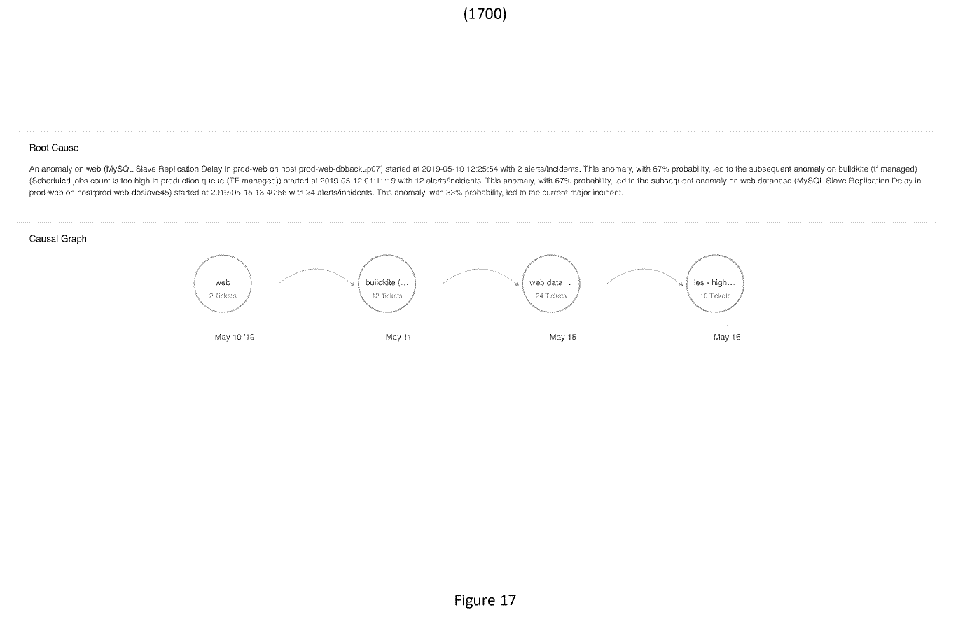

Each discovered causal relation between different anomalies of different clusters have associated correlation confidence (probability) and correlation window (e.g., 12 hours). For each major incident, if historically learned anomalous relations occur within the correlation window of a major incident and are above the tolerance confidence (can be adjusted by the agent), they will be added to the causal view of that major incident. This may continue for the causal nodes which are discovered as root cause, as well. In some cases, the major incidents algorithm attempts to find root cause for discovered root causes. This is done by traversing at most 5 edges (5 hops) in the causal graph. In some cases, the root cause description may explain the discovered causal view, if it was traversed backward in time with choosing the path with higher probability at each level (i.e., greedy method). For example, as illustrated in FIG. 17, an assignment group is predicted for each major incident to facilitate routing of an issue and improve a mean time to repair (MTTR). The PRCA engine 870 may achieve this by first predicting the most likely assignment group of an alert/incident, when it is not provided. The PRCA engine 870 may then choose the dominant assignment group of all incidents and alerts as the assignment group of that major incident.

In some cases, the system 800 comprises a work-bench annotation (WBA) engine 880. The WBA engine may be configured to provide support agents 802 investigating predicted service incidents with relevant data. Relevant data may include past service incidents which are verified and accepted by the support agents 802 which share similarity with active incidents under investigation. The WBA engine 880 may further provide users 802 with tools to edit model outputs from one or more other engines in the system. For example, the WBA engine 880, may provide a user 802 with one or more tools to edit a confidence score of a derived statistical causal association between CIs, or add a missing CI, etc. In some cases, the WBA engine 880 is configured to allows the agents 802 a user interface to help the user 802 understand both how the advanced AI analytics have derived a prediction and identify and correct mistakes made by one or more engines of the system.

In some cases, the WBA engine 880 is configured to help the system 800 learning over time. In some cases, the WBA engine 880 provides the system 800 one or more way of collecting agent's feedback. Agent feedback may comprise the user's domain knowledge. In some cases, the WBA engine 880 collects agent/user feedback to tailor and calibrate one or more engines and/or one or more algorithms to fit the needs of an IT organization. In some cases, the system can and move from generating mainly probabilistic results to more deterministic discoveries based on confirmed inferred relations. In some cases, the WBA engine provides agents 802 with an user feedback interface. The user feedback interface may allow the agents/users 802 to confirm inferred relations determined by the system 800.

In some cases, the WBA engine 880 provide the system 800 with one or more methods for capturing agent/user feedback to be leveraged by a probabilistic model self-calibration (PMSC) engine.

In some cases, a user feedback interface allows a user/agent 802 to rate each predicted service outage or service degradation generated from the PSIP engine 860. The rating can be a thumbs up or thumbs down. This may provide useful feedback regarding the reliability and accuracy of the predictions which can be used for calibration of future predictions.

In some cases, a user feedback interface allows a qualified or verified user/agent 802 the ability to deactivate a specific type of major incident. In some cases, a major incident is valid and has a good correlation but does not require escalation and is therefore muted in future. In some cases, a major incident has a correlation that is invalid and the relations for this major incident will be nullified and recomputed again.

In some cases, a user feedback interface allows a qualified or verified user/agent 802 the ability to change the underlying logic which leads to formation of major incidents by either cloning a ML generated major incident and impose additional constraint, or even creating a logic for a major incident type from scratch by providing conditions for grouping alerts and incidents.

In some cases, a user feedback interface allows a qualified or verified user/agent 802 the ability to confirm, revoke, and/or enrich discovered relations between configuration items. In some cases, the user 802 can provide configuration items naming convention for discovery of relations between configuration items and business services. In some cases, the naming convention provided by the user 802 can be used for more deterministic discovery of relations between configuration items and business services.

In some cases, a user feedback interface allows a qualified or verified user/agent 802 the ability to provide additional requirements for escalating them by for example configuring rate of alerts/incidents among other things. In some cases, the user 802 can provide additional requirements for escalating them by for example configuring rate of alerts/incidents even when the quality of the correlation between incidents/alerts, configuration items, users, etc. is valid.

In some cases, a user feedback interface allows a qualified or verified user/agent 802 the ability to reject probabilistic causal relations. In some cases, a user feedback interface allows a qualified or verified user/agent 802 the ability to convert can be rejected or be converted into deterministic ones.

In some cases, the WBA engine 880 may receive information related to successful and/or possible remediation of a service incident. remediation actions and information may be configured to capture possible remediation actions and information for a major incident and present remediation actions and information for similar future major incidents. In some cases, the WBA engine 880 may use the captured possible remediation actions and information for a major incident for enriching the knowledge graph of major incidents. In some cases, the WBA engine may be configured to present a user 802 with knowledge graphs of major incidents. The knowledge graphs may comprise, predicted timeline information for a major incident, historical timeline information for same and/or similar major incidents, service outage prediction for a major incident, historical service outage predictions for same and/or similar major incidents, a list of predicted impacted CIs and/or services for a major incident, historical lists of impacted CIs and/or services for same and/or similar major incidents, etc.

In some cases, a user feedback interface allows a qualified or verified user/agent 802 the ability to provide feedback related to predicted routing for major incidents. In some cases, the predicted routing for major incidents can be overwritten by the feedback captured by the WBA engine 880.

In some cases, the WBA engine allows users/agents 802 insight and transparency to the details about the algorithm's inner works. This makes the methods and systems for incident and service management less of a black box solution and easier to understand by the users. In some cases, the WBA engine 880 is configured to provide received user/agent feedback to the PMSC engine 890.

In some cases, the PMSC engine can improve and tailor the algorithms generated and utilized by other engines of the system 800 based on the feedback received from the WBA Engine 880. In some cases, the PMSC engine 890 is configured to continuously learn from past predictions—successes and failures—and auto-adjust one or more engines of the system 800 and/or one or more algorithms of the one or more engines. The PMSC engine 890 may be configured to auto-adjust the one or more engines of the system 800 and/or the one or more algorithms of the one or more engines without the need of support agent supervision. The PMSC engine 890 may continuously collect new data in real-time. The PMSC engine 890 may use the collected new data to assess whether the new data complies with the service outage model predictions. The PMSC engine 890 may use the collected new data to assess whether the new data complies with data related to the business service, incident stage (early warning, levels of performance degradation and outage/interruption) and the predicted time for stage transition output by the service outage model. In some cases, the PMSC engine 890 is configured to raise a confidence score and/or the trustworthiness of the relationships learned by the PSIP engine 890, when the new data collected in real-time is aligned with the model predictions. In some cases, the PMSC engine 890 is configured to lower a confidence score and/or the trustworthiness of the relationships learned by the PSIP engine 890, when the new data collected in real-time is diverges from the model predictions. In some cases, the PMSC engine 890 is configured to regularly receive these deviations to auto-calibrate the system 800. In some cases, the PMSC engine 890 is configured to collect the changes provided by support agents 802 via the WBA engine 880.

In some cases, the PMSC engine 890 is configured to perform model calibration to the one or more models described herein. In some cases, the PMSC engine calibrates one or more models of the system using algorithms self-evaluation methods and/or by leveraging the captured feedback and domain knowledge from users and agents received by the WBA engine 880.

In some cases, the one or more algorithms and/or models of the system 800 continuously make predictions for a given prediction window of the future. Once the time passes for the given prediction window, the PMSC engine 890 may an evaluate the predictions of the models and/or algorithms of the system 800. In some cases, the models and/or algorithms of the system 800 may self-calibrate based at least in part on the evaluation of the predictions. For example, outage prediction of a specific type of major incidents can be adjusted based on whether or not the predicted behavior occurred or not.

In some cases, the PMSC engine 890 uses the receive feedback data from the WBA engine 880 as an enriched supplementary input for calibrating the models. For example, if a major incident is marked an invalid, MEC engine 840 may reassign its incidents/alerts based on agent feedback from the WBA engine 880 and/or different distance metrics in vector space. In some cases, the impact score may be adjusted based on configuration modification on historic major incidents. In some cases, the outage probability of a major incident is tuned based on the fraction of thumbs up to thumbs down for the specific type of the major incident. In some cases, inferred causal models of the PCI engine 850 may be adjusted for the correlation probabilities in response to receiving feedback related to the discovered relations between one or more configuration items and/or one or more business services. In some cases, inferred causal models of the PCI engine 850 may be adjusted for the correlation probabilities in response to receiving feedback related to the discovered causal model. In some cases, the PMSC engine 890 leverages captured naming convention from agents to improve clustering performed by the MEC engine 840, causal relation inference performed by the PCI engine 850, and service outage prediction results generated by the PSIP engine 860.

In some cases, The WBA engine 880 may present a recommendation for remediation of a future major incidents if remediation data for the predicted future major incident is available.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented method for incident and service management, the method comprising:
a) receiving a plurality of historical alerts, incidents, or service tickets;
b) processing the plurality of historical alerts, incidents, or service tickets and extracting key feature data;
c) grouping the plurality of historical alerts, incidents, or service tickets into one or more clusters based at least in part on the extracted key features;
d) deriving probabilistic causal relation data between two or more clusters of the one or more clusters;
e) generating an statistical model from the plurality of historical alerts, incidents, or ticket services, wherein the statistical model is configured to predict major service incidents (MIs) from the plurality of historical alerts, incidents, or service tickets;
f) identifying root cause configuration items (CIs) from the plurality of the plurality of historical alerts, incidents, or service tickets; and
g) generating a service incident interface configured to provide personalized service incident recommendations to a user based on one or more business and operational priorities.

2. The method of claim 1, wherein processing the plurality of historical alerts, incidents, or service tickets enables a customer to define a plurality of groups of services based on relative importance to a business or operation of the customer, thereby distinguishing between critical services and important services.

3. The method of claim 2, wherein the relative importance is estimated based on the number of outages, users, and configuration items.

4. The method of claim 1, wherein processing the plurality of historical alerts, incidents, or service tickets provides the user or the support agent with a recommended ranking of configuration items and business applications.

5. The method of claim 1, wherein processing the plurality of historical alerts, incidents, or ticket services ingests and leverages data from one or more different alert monitoring tool or a ticketing system.

6. The method of claim 1, wherein processing the historical alerts, incidents, or ticket services comprises parsing both the structural and unstructured information uses advance Natural Language Processing (NLP) techniques from machine learning/artificial intelligence (ML/AI).

7. The method of claim 6, wherein the unstructured ticket information comprises ticket description, resolution information, and ticket topological information.

8. The method of claim 6, wherein processing the historical alerts, incidents, or ticket services comprises parsing unstructured ticket information comprises tagging, normalizing, and extracting one or more key features of the service tickets.

9. The method of claim 6, wherein parsing the unstructured ticket information reduces a noise in the unstructured ticket information and leaves a key information needed for a later step.

10. The method of claim 6, wherein parsing both the structured and unstructured ticket information is fully automatic and unsupervised by using ML/AI algorithms.

11. The method of claim 6, wherein parsing both the structured and unstructured ticket information comprises extracting semantic information from both the structured and unstructured ticket information.

12. The method of claim 11, wherein the extracted semantic information comprises a ticket temporal information, wherein the ticket temporal information comprises an overall life-cycle of the service ticket or a change of status from creation to validation of the service ticket.

13. The method of claim 11, wherein the extracted semantic information comprises a ticket severity information, wherein the ticket severity information comprises a severity in relation to the SLA.

14. The method of claim 11, wherein the extracted semantic information comprises a ticket topological information, wherein the ticket topological information comprises an origin of a service problem within an Enterprise network and an affected element or service.

15. The method of claim 11, wherein the extracted semantic information comprises a ticket description and resolution information, wherein the resolution information comprises both a service problem and a final resolution of the service problem at the time of ticket closure.

16. The method of claim 6, wherein parsing both the structural and unstructured information further uses advanced Natural Language Understanding (NLU) techniques to impute if one or more key features of the service tickets are missing.

17. The method of claim 1, wherein each of the one or more clusters comprises a specific type of issue that occurred previously.

18. The method of claim 1, wherein grouping the plurality of historical alerts, incidents, or service tickets uses a MEC algorithm, wherein the MEC algorithm automatically discovers one or more meaningful clusters.

19. The method of claim 18, wherein the MEC algorithm learns from a feedback from a user or a support agent.

20. The method of claim 18, wherein the MEC algorithm comprises:
(a) filtering out one or more service tickets that are not important and do not contribute to one or more major incidents;
(b) preprocessing one or more text features;
(c) concentrating the preprocessed one or more text features and converting them into one or more vectors;
(d) performing a main clustering process; and
(e) fine-tuning the one or more larger and meaningful clusters, wherein the fine-tuning comprises a hard split or a soft split.

21. The method of claim 20, wherein, in (d), performing the main clustering process comprises a hierarchical structure comprising:
(f) performing a first unsupervised clustering with a pre-defined and relatively-large value of total number of clusters (k) and constructing a plurality of small and dense clusters;
(g) treating each of the plurality of small and dense clusters as a single data point;
(h) performing a second unsupervised clustering on the single data point, thereby merging one or more of the single data point into a larger cluster; and
(i) repeating steps (f) to (h) until a meaningful and relatively-sizable representation of clusters are obtained.

22. The method of claim 1, wherein derived the probabilistic causal relation comprises:
(j) applying the Ganger causality test to identify a candidate list of cluster pairs that can have causal relations;
(k) applying a potential outcomes causal inference to validate the causal relation and quantify the causal effect; and
(l) discovering a hidden configuration item relation based on the discovered probabilistic causal relation.

23. The method of claim 22, wherein, in (k), applying the potential outcomes causal inference comprises:
(m) modeling a cluster causal relationship using a causal graph, wherein the causal graph comprises prior knowledge of a causal relationship between two clusters, a causal relationship to be evaluated, or a cluster of incident tickets;
(n) finding any possible ways of identifying a desired causal effect based on the causal graph;
(o) estimating the causal effect by using a statistical method, wherein the statistical method comprises propensity-based stratification or propensity-score-matching; and
(p) verifying the causing effect by using a robustness method, wherein the robustness method comprises a Placebo Treatment.

24. A computer-implemented system comprising at least one processor and instructions causing the at least one processor to perform operations, the system comprising:
a) a custom-tailored recommendation for service incident (CRSI) engine configured to processes a plurality of historical alerts, incidents, or service tickets and generate a tailored rendering and prioritization of a predicted service incident based on an operational need of a customer at a given time;
b) a service ticket semantic parsing (STSP) engine configured to ingest the plurality of historical alerts, incidents, or service tickets and parse both structured and unstructured ticket information;
c) a multi-dimensional clustering (MEC) engine configured to group the plurality of historical alerts, incidents, or service tickets into one or more clusters;
d) a probabilistic causal inference (PCI) engine configured to discover a probabilistic causal relation and estimate a causal effect between two or more clusters;
e) a probabilistic service incident prediction (PSIP) configured to auto-generate a statistical model from the plurality of historical alerts, incidents, or ticket services;
f) a probabilistic root cause analysis (PRCA) engine configured to identify root cause configuration items (CIs);
g) a work-bench annotation (WBA) engine configured to provide a user or a support agent with relevant data and one or more tools to edit a probabilistic model output and collect feedback and domain knowledge from the user or a support agent; and
h) a probabilistic model self-calibration (PMSC) engine configured to review the feedback and domain knowledge from the WBA engine and predict a service outage from the plurality of historical alerts, incidents, or service tickets.

25. One or more non-transitory computer-readable storage media encoded with instructions executable by one or more processors to provide an application configured to perform operations comprising:
a) receiving a plurality of historical alerts, incidents, or service tickets;
b) processing the plurality of historical alerts, incidents, or service tickets in a custom-tailored recommendation for service incident (CRSI) engine configured to tailor the rendering and prioritization of a predicted service CRSI incident based on an operational need of a customer at a given time;
c) ingesting the plurality of historical alerts, incidents, or service tickets and parsing both the structured and unstructured ticket information in a service ticket semantic parsing (STSP) engine;
d) grouping the plurality of historical alerts, incidents, or service tickets into one or more clusters in a multi-dimensional clustering (MEC) engine;
e) discovering a probabilistic causal relation and estimating a causal effect between two or more clusters in a probabilistic causal inference (PCI) engine;
f) auto-generating a statistical model from the plurality of historical alerts, incidents, or ticket services in a probabilistic service incident prediction (PSIP) engine;
g) identifying root cause configuration items (CIs) in a probabilistic root cause analysis (PRCA) engine;
h) providing a user or a support agent with relevant data and a tool to edit a probabilistic model output to collect a feedback and domain knowledge from the user or a support agent in a work-bench annotation (WBA) engine; and
i) receiving the feedback and domain knowledge from the WBA engine in a probabilistic model self-calibration (PMSC) engine;
thereby providing an outage prediction to a user or a support agent.
